(19) United States
(12) Patent Application Publication
(10) Pub. No.: US 2009/0119080 A1
(43) Pub. Date: May 7, 2009

(54) Computational simulation systems and methods using boundary integral equations

(76) Inventors: Leonard J. Gray, Oak Ridge, TN (US); Patrick Gaffney, Bergen (NO)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/989,634

(22) PCT Filed: Aug. 26, 2005
(86) PCT No.: PCT/US05/30336

§ 371 Date: Jan. 13, 2009

Related U.S. Application Data
(60) Provisional application No. 60/604,803, filed on Aug. 27, 2004.

(51) Int. Cl. G06G 7/48; G06T 17/00

(52) U.S. Cl. 703/8; 345/420

(57) ABSTRACT

A system, method, and computer-readable medium including instructions for predicting a characteristic of an object is described. The system includes an object model comprising a thin crack geometry representation of at least a portion of the object; a boundary condition model of a predetermined process applicable to the object (FIG. 8, Input Data); and a simulator module (FIG. 8, Run the EPD Simulator) for simulating the application of the output (FIG. 8, Output Results) a predicted value of a predetermined characteristic of the object.

### FIELD OF THE INVENTION

The present embodiments relate to simulating processes applied to objects with respect to time.

### BACKGROUND

It is known in the art to simulate processes, e.g., industrial processes, in order to answer questions without requiring construction of physical prototypes and without performing a series of experiments on the constructed prototypes followed by analysis of the experiment results. Using a brute force approach, i.e., constructing and experimenting on prototypes, does not guarantee success as the number of experiments possible is limited by the cost of constructing prototypes and performing experiments. For example, if the prototypes involved are vehicles, construction of prototypes for use in experiments, e.g., vehicle paint applications, is prohibitively high as in order to analyze the results, each prototype needs to be effectively destroyed.

### SUMMARY

The present embodiments provide a method of simulating processes applied to objects with respect to time.

A method embodiment includes predicting a characteristic of an object. An object model comprising a thin crack geometry representation of at least a portion of the object is created. A boundary condition model of a predetermined process applied to the object is created. A simulation of application of the predetermined process to the object is performed, where the simulation is operable to apply the boundary condition model to the object model and to output a predicted value of a predetermined characteristic of the object.

A system embodiment for predicting a characteristic of an object includes an object model comprising a thin crack geometry representation of at least a portion of the object; a boundary condition model of a predetermined process applied to the object, wherein the boundary condition model comprises a Green's function; and a simulator module for simulating application of the predetermined process to the object, the simulator module operable to apply the boundary condition model to the object model and to output a predicted value of a predetermined characteristic of the object.

Still other advantages of the present embodiments will become readily apparent to those skilled in the art from the following detailed description, wherein the preferred embodiments are shown and described, simply by way of illustration of the best mode contemplated of carrying out the invention. As will be realized, other and different embodiments are possible, and the several details are capable of modifications in various obvious respects, all without departing from the scope and spirit of the present embodiments.

### DESCRIPTION OF THE DRAWINGS

The present embodiments are illustrated by way of example, and not by limitation, in the figures of the accompanying drawings, wherein elements having the same reference numeral designations represent like elements throughout and wherein:

FIG. 1 is a flow chart according to an embodiment;

FIG. 2 is an example part useable in conjunction with an embodiment;

FIG. 3 is an exploded model view of the FIG. 2 part;

FIG. 4 is another view of the FIG. 2 part highlighting certain portions of the part;

FIG. 5 is a simulation view of an electro-paint deposition process useable in conjunction with an embodiment;

FIG. 6 is a high level overview of an architecture useable in conjunction with an embodiment;

FIG. 7 is a flow chart of a portion of an embodiment;

FIG. 8 is a high level flow chart of execution of an embodiment;

FIG. 9 is a flow chart of another portion of an embodiment;

FIG. 10 is a detailed flow chart according to the FIG. 9 flow chart;

FIG. 11 is another view of the FIG. 2 part highlighting certain portions of the part;

FIG. 12 is another view of the FIG. 2 part highlighting certain portions of the part;

FIG. 13 is another view of the FIG. 2 part highlighting certain portions of the part;

FIG. 14 is another view of the FIG. 2 part highlighting certain portions of the part;

FIG. 15 is another view of the FIG. 2 part highlighting certain portions of the part;

FIG. 16 is a schematic view of pieces of a model of the FIG. 2 part;

FIG. 17 is another view of the FIG. 2 part highlighting certain portions of the part;

FIG. 18 is a flow chart of execution of a portion of an embodiment;

FIG. 19 is a high level diagram of two adjacent surfaces;

FIG. 20 is a high level diagram of the surfaces of FIG. 19;

FIG. 21 is a high level diagram of another representation of the surfaces of FIG. 19;

FIG. 22 is a schematic representation of the FIG. 2 part;

FIG. 23 is a high level diagram of a representation of two surface;

FIG. 24 is a schematic representation of a portion of the FIG. 2 part;

FIG. 25 is a high level flow chart of a portion of an embodiment;

FIG. 26 is a schematic representation of a tank useable in conjunction with an embodiment;

FIG. 27 is a screenshot of a window of a user interface of an embodiment;

FIG. 28 is another screenshot of a window of a user interface of an embodiment;

FIG. 29 is a schematic representation of a tank, anodes, and a cathode according to an embodiment;

FIG. 30 is a screenshot of a window of a user interface of an embodiment;

FIG. 31 is a high level flow chart of an anode type determination according to an embodiment;

FIG. 32 is a schematic representation of a portion of FIG. 29;

FIG. 33 is a schematic representation of two different simulations according to an embodiment;

FIG. 34 is a high level flow chart of a portion of an embodiment;

FIG. 35 is a high level architecture of a network according to an embodiment;

FIG. 36 is a high level architecture of a computational grid according to an embodiment;

FIG. 37 is a high level structure diagram of an embodiment;

FIG. 38 is a high level flow chart of a portion of an embodiment

FIG. 39 is a flow chart of an input generation portion of an embodiment;

FIG. 40 is a screenshot of a user interface according to an embodiment;

FIG. 41 is another screenshot of a user interface according to an embodiment;

FIG. 42, made up of FIGS. 42a and 42b, is a listing of a portion of a file representing an input according to an embodiment;

FIG. 43 is a schematic representation of a tank, anode, and cathode according to an embodiment;

FIG. 44 is a screenshot of a user interface window according to an embodiment;

FIG. 45 is another screenshot of a user interface window according to an embodiment;

FIG. 46 is a another screenshot of several user interface windows according to an embodiment;

FIG. 47 is a screenshot of a user interface window of FIG. 46;

FIG. 48 is another screenshot of several user interface windows according to an embodiment;

FIG. 49 is another screenshot of several user interface windows according to an embodiment;

FIG. 50 is a screenshot of a part and an indicator of difference between two surfaces;

FIG. 51 is another screenshot of several user interface windows according to an embodiment;

FIG. 52 is a high level flow chart depicting an example scenario according to an embodiment;

FIG. 53 is an example 3D comparison palette according to an embodiment;

FIG. 54 is an example 1D comparison palette according to an embodiment;

FIG. 55 is a high level block diagram of a computer system usable in conjunction with an embodiment; and

FIGS. 56-59 are high level block diagrams of a process flow of a computational grid according to an embodiment.

### DETAILED DESCRIPTION

Embodiments according to the present invention simulate processes of a type sharing some or all of the following characteristics:
1. The processes are applied to complicated three-dimensional (3D) objects composed of thin surfaces, e.g., thin pieces of metal;
2. It is prohibitively expensive to conduct physical trial-and-error experiments in order to understand and better control the physical process, and;
3. It is important to know what happens over time and at a given point in time.

Example processes and corresponding sample questions which may be addressed by the present embodiments include:
How much of a truck has been dried after 30 seconds in a paint oven?
How much paint has accumulated on a bottom surface of a door frame after it has been 90 seconds in a paint tank?
How can we be assured that minimum coating requirements are satisfied everywhere in a vehicle after immersion in a tank for 120 seconds?

As described above, determining answers to these and similar questions, without involving simulation, requires construction of physical prototypes, conducting a series of experiments where the processes are applied to the prototypes, and analyzing the results. There is no guarantee of success with this procedure because the number of experiments is limited by the costs for constructing prototypes, e.g., trucks and cars, is prohibitively high.

Simulation of processes of the type described above is the focus of the system addressed herein. In particular, simulation of processes having the above characteristics and in addition:
4. The process can be described by a mathematical statement approximating physical, chemical and other properties of the process, and;
5. The process is amenable to simulation by Boundary Integral Methods.

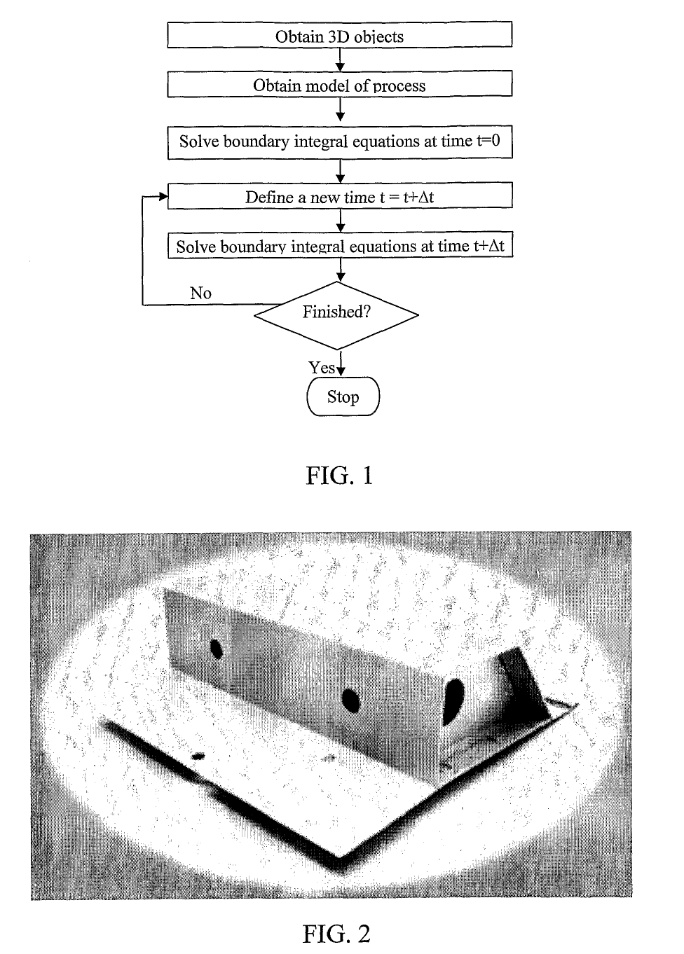

Given the above five characteristics, FIG. 1 depicts a flow chart of the main steps of the simulation strategy described below. With respect to the FIG. 1 flow chart, the flow includes solving the equations for time t=0 because obtaining a closed form solution for a general value of t is not possible. In this case, the equations for t=0 and a Δt chosen small enough to be possible to solve the equations at t+Δt are solved. The process continues until t reaches the end time of the simulation period.

It is important to determine a Δt such that the end time of the simulation period is reachable in a practical time. For example, if the solution of the boundary integral equations dictates that every value of Δt must not be larger than 0.0000001 seconds and the end of the time period is 1 hour then a substantial amount of computing time will be incurred. The methods used in an embodiment of the EPD Simulator allow the time step Δt to be significantly larger than the above quantity and so a simulation over a realistic time period of, for example, 240 seconds is achievable for EPD.

In another embodiment, Δt may be varied. In other words, instead of using a fixed value for all time steps, a variable time step is used thereby reducing the time taken to execute realistic simulations.

In another embodiment, the order in which the first two steps are performed has little or no effect on the later outcome.

### Boundary Integral Methods

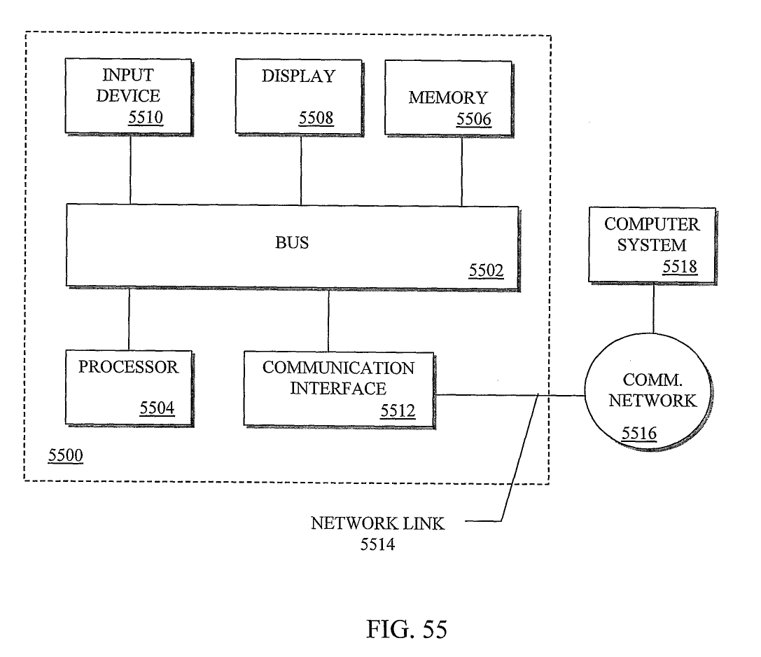

The embodiments described herein utilize a mathematical description of processes, e.g., industrial processes, that may result in partial differential equations specified over a region in three-dimensional space, e.g., x, y, z coordinates. In all but the most simple and trivial cases, a computer, e.g., computer system 5500 described below in conjunction with FIG. 55, executing software solves the equations and consequently the equations are reformulated such that they are amenable to numerical or computational methods.

A Finite Element Method is a computational method usable for solving complex three-dimensional partial differential equations, resulting from the mathematical and numerical modeling of processes, especially processes requiring knowledge of what happens in an interior of a given region in space.

Another method involves recasting the partial differential equations as integral equations and then employing Boundary Integral Methods to obtain a solution. For one embodiment, a fundamental solution, such as a Green's function, is used to solve the partial differential equations. A Green's function is an integral kernel for solving an inhomogeneous differential equation having boundary conditions. The Green's function used depends on the differential equation, the body shape, and the type of boundary conditions present. A Green's function exists for a smaller set of problems than is solvable using the finite element method. However, for many engineering problems it is possible to determine a Green's function and for these cases boundary integral methods are an alternative solution technique to the finite element method. Boundary integral methods are useful for determining what happens on the boundary of a closed region as opposed to the interior of the region. There are many processes where the solution is only required on the boundary and for these cases, boundary integral methods are often the only practical approach because including the interior of the region in the solution may be computationally intractable. Three particular processes where a solution is required on the boundary include:
Electrochemical processes;
Transient heat flow in an oven, and;
Crack propagation in a non-homogeneous material.

In broad terms, the solution described below deals with the simulation of processes amenable to solution by boundary integral methods. However, this set of processes has an important subset that is much more difficult to solve because not only are the processes space-dependant, they are time-dependant, as well. This particular subset is addressed by the solution described below.

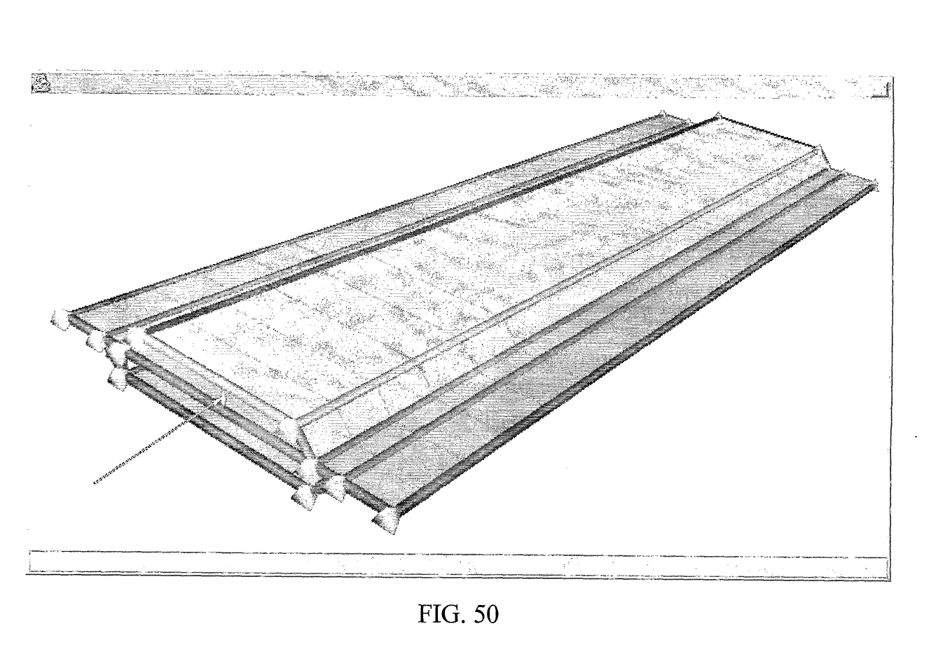

According to an embodiment, a computational problem requires a computational mesh be applied to an entire object, including the edges of the object. When the distance between the top and bottom of an edge is sufficiently small then the object is determined to be thin. In this situation, two difficulties occur computationally:
1. Mathematical problems occur when numerical integrations are attempted to be performed across the top and bottom of the edge of an object. These problems manifest themselves as singularities and occur when integrating across two surfaces positioned sufficiently close together. For example, as depicted in FIG. 50, as the distance indicated by the arrow identifying a distance between a top surface and a middle surface decreases, the top and middle surfaces of the object move closer together and numerical integrations across these two surfaces become exceedingly difficult.
2. Practical difficulties occur in attempting to apply a mesh on a thin edge. For example, the top surface edge as depicted in FIG. 50 is a thin edge and would be practically difficult to apply a computational mesh on the edge.

According to an embodiment, the solution, mathematically and computationally, lies in treating the thin object as infinitely thin crack geometry. In the example above, the top, middle, and bottom surfaces are treated as thin surfaces and handled computationally as infinitely thin geometry.

The EPD™ System uses the concept of thin surfaces in two distinct situations:
1. The thinness of an object causes mathematical problems for the computational process, and;
2. The thickness of an object does not contribute to the physical process being simulated.

The first situation has been discussed above. An example of a thin object is sheet metal. However, the strategy is not confined to any particular material, e.g., metal, because the process is applicable for any object where the edges of the object are close together.

The second situation applies to an object not considered to be thin, in the sense described above. In this case, the strategy is: Why waste time and storage on meshing the edges of the object when they do not contribute to the process being simulated? The thickness is ignored and the object treated as thin and analyzed as infinitely thin crack geometry.

### Thin Surfaces

In many applications, the boundary of the region of interest is such that no, or very little, special consideration is made when implementing numerical methods in software. The situation is quite different when dealing with certain processes often having regions of interest with complicated shapes and features causing difficulties for both the process being simulated and the methods used for the simulation. In particular, thin surfaces, such as a metal box depicted in FIG. 2 and constructed from several pieces of thin metal, cause a problem for numerical methods.

To apply numerical methods for solving partial differential equations over the metal box region requires the edges of the region to be discretized with a computational mesh. This is not an easy task due to the thinness of the metal. A more serious concern arises when integration is to be performed over two pieces of metal positioned close together, which exists when the region is composed of thin metal. In this case, singularities arise in the integration and have to be dealt with in the numerical methods to avoid catastrophic breakdown of the simulation.

According to one mathematical approach, thin metal is modeled as an infinitely thin crack geometry because doing so avoids difficult near singular integrals and avoids meshing the edges.

However, another advantage of the thin crack geometry approach is if the thickness of the metal does not contribute to the solution of the simulation problem, then the thickness is ignored, the metal is treated as thin metal and handled numerically as a thin crack geometry. Using this approach increases the size of the problems able to be handled computationally, which is a tremendous benefit in handling complex processes.

With respect to a deposition process using a cathode and an anode to deposit a material on a given part, thin metal is not confined to the geometry of the cathode (for example, a car part or frame in the electro-paint deposition process) as anodes may also be treated as thin metal. For example, a cylindrical-shaped anode without a closing cap at either end forms a hollow tube, which is effectively treated as a thin surface. In contrast, a cylindrical anode with caps at both ends forms a closed tube, which has a definite volume and is therefore not possible to treat as a thin surface, i.e., a thin metal. In the latter case, thickness matters and therefore this type of geometry is treated as a ‘thick’ surface.

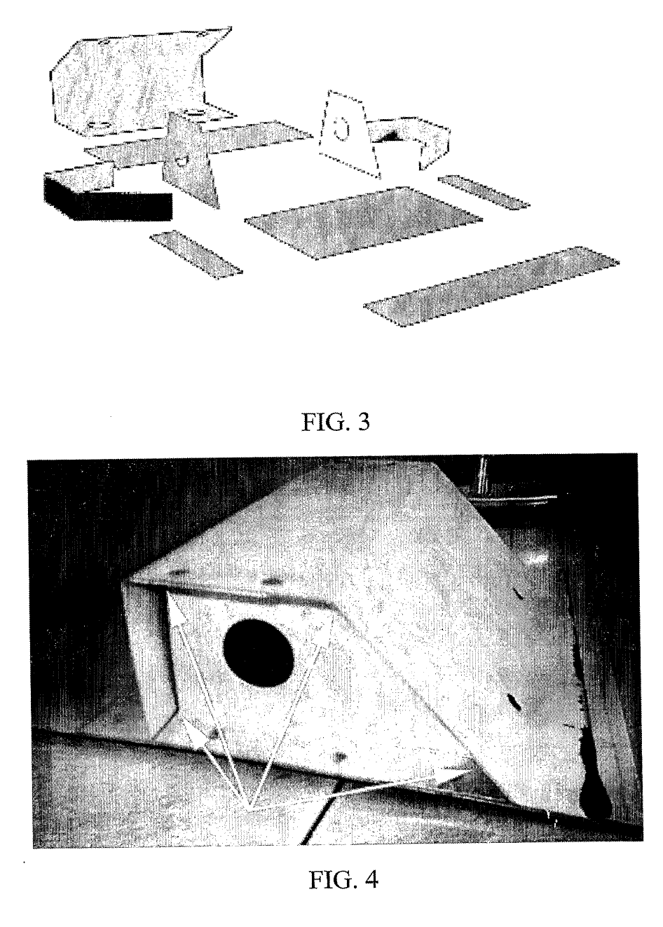

To convert a thick region, i.e., a thick surface, into a thin region requires a method for partitioning an arbitrary region into thin surfaces (thereby removing the thickness) and another method for re-stitching the surfaces back together again to obtain a complete thin surface geometry. For example, the object depicted in FIG. 2 is partitioned into the thin surfaces depicted in FIG. 3.

In order to work with a particular partitioning in a simulation, the individual thin part surfaces are ‘re-stitched’ back together.

Practical difficulties arise in regions having joints where several surfaces meet, e.g., as depicted in FIG. 4 arrows indicate places where several pieces of thin metal come together. Because each piece of thin metal is treated as an infinitely thin crack geometry, a method is devised for treating these junctions accordingly.

The present inventors have developed novel techniques for applying thin crack geometry to arbitrary regions, in particular techniques for:
Partitioning an arbitrary region into thin surfaces;
Re-stitching the surfaces back together again, and;
Treating junctions of thin surfaces in a mathematically correct manner.

### Fast Solution Methods

Discretizations of boundary integral equations typically lead to the formation and solution of a system of linear equations with a dense coefficient matrix. The dimension N of the matrix is very large and therefore iterative solvers are more appropriate than direct solvers for the solution of the linear equations.

When using iterative solvers, the coefficients of the matrix are not explicitly needed because these solvers operate by using matrix vector multiplications. Consequently, to solve industrial problems efficiently, the boundary integral methods are reformulated in a way that makes fast matrix vector multiplications possible. For example, two strategies for this reformulation are fast summation methods (FSM) and multi-scale methods (MSM).

One class of FSM techniques is the Fast Multipole Method (FMM), which has a subclass called the Spectral Multipole Method. With this method, the O(N²) effort to compute the coefficient matrix is replaced by an effort that scales nearly as O(N) and the O(N²) operations for matrix vector multiplications are reduced to O(NLogN).

In the described embodiments, the use of FMM in boundary integral methods includes using the Spectral Multipole Method with particular emphasis on problems with the following profile:
They are amenable to solution using Boundary Integral Methods;
They simulate industrial processes that depend on time; and
They require thin surface treatment.

### The Model

A model is a mathematical statement describing the industrial process in terms of parameters that approximate physical, chemical and other properties of the process.

For example, the sample questions given earlier, and repeated here for convenience, each relate to a different model.
How much of the truck has been dried after 30 seconds in the paint oven?
To answer this question requires a model of heat transfer in the paint oven as a function of time. Since there are three forms of heat: conduction, convection, and radiation, the model will contain contributions for each of these quantities in terms of parameters that describe how the heat is transferred to the surface of the truck while it is in the oven.
How much paint has accumulated on the bottom surface of the door frame after it has been 90 seconds in the paint tank?
How can we be assured that minimum coating requirements are satisfied everywhere in the vehicle after immersion in the tank for 120 seconds?
Both of these questions require a model of how paint deposits on the surface of a vehicle as time evolves.

One characteristic of these samples and of industrial processes in general, is that their respective models are not unique. Practitioners will have their own ideas of what parameters to include in a model. This is definitely not a drawback for as long as it is possible to provide a mathematical statement that describes the process as time evolves then the system described in the present embodiments is applicable.

### Business Considerations

One embodiment according to the present invention is intended for deployment in commercial, industrial, production environments. This means the solution may exist within the framework imposed by the objectives and policies of a commercial enterprise. In such a situation, business and operational procedures may be just as important as the accuracy of the numbers produced from the simulation. Consequently, the solution pays great attention to how a simulation is performed and what happens to it afterwards.

### SUMMARY

One or more of the characteristics of the industrial processes addressed by the present embodiments are described as follows:
1. The processes are applied to complicated three-dimensional (3D) objects composed of thin surfaces, for example, thin pieces of metal.
2. It is expensive, and oftentimes prohibitively expensive, to conduct physical trial-and-error experiments in order to understand and better control the physical process.
3. It is important to know what happens in time.
4. The process can be described by a mathematical statement that approximates physical, chemical and other properties of the process.
5. The process is amenable to simulation by Boundary Integral Methods.

One or more of the techniques listed below are used in the described embodiments:
Boundary Integral Methods incorporating
   Fast solution methods
   Time dependent methods
   Complex three-dimensional geometry
   Treatment of thin surfaces
Business considerations
   Security
   Auditing
   Requirements for different user groups

Electro-Paint Deposition

For automobile manufacturers, durable, corrosion-resistant designs continue to be a very desirable feature. In Europe, for example, manufacturers have started to offer 10 and 12-year corrosion warranties. To assure long-term customer satisfaction, the process to apply rust-preventing coatings must ensure that all parts of the vehicle have an adequate minimum build of paint. Currently, the main method used to minimize salt spray induced corrosion involves application of an epoxy-based urethane coating using an electrodeposition technique. This paint is applied to the vehicle while it is submerged in a large tank filled with the resin and pigments that make up this paint.

FIG. 5 depicts a typical tank with anodes placed along the top, bottom, and sides. Car parts are suspended from a gantry, which serves to lower and transport them through the tank filled with the epoxy-based urethane paint. Each part is treated as a cathode and by applying electricity to the anodes; the paint adheres to the car part.

To ensure surfaces that are awkward to reach have at least the specified minimum needed coating of paint, the manufacturer usually places a pattern of holes in the vehicle to form channels for electric current to deposit paint on the inner faces of these surfaces. The number and distribution of holes must be determined to guarantee all surfaces are adequately painted, without compromising structural stability and crash-worthiness of the vehicle.

EPD is the name of a new computer system for predicting paint distribution on automotive parts. The system is intended to make it easy for designers to explore different scenarios without the need to resort to costly physical trial-and-error testing. Additionally, the system can be used by tank operators to optimize the configuration of anodes in the tank used for the electrodeposition process.

### The EPD™ System

BSSI's computer software for simulating the electro-paint deposition process together with any associated subsystems required for deploying the software in operational environments is called the EPD™ System.

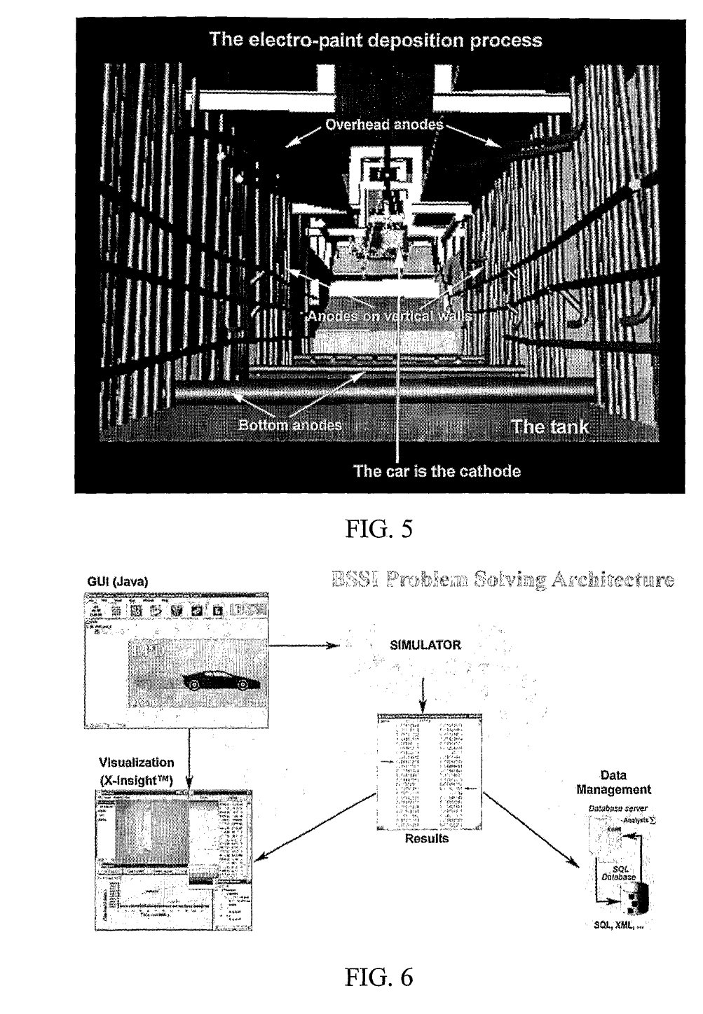

The EPD™ System is built to conform to BSSI's architecture for problem solving environments, the major components of which are depicted in FIG. 6.

The main characteristic of this environment is that it provides the framework for managing the complete life cycle of a simulation—from conception through storage and dissemination of the results from scenarios. Systems built to conform to this framework are intended for deployment in commercial, operational, research, and production environments where security and the fidelity of data are of paramount importance.

The EPD™ System achieves these objectives using one or more of the following major components:
The Simulator
Computational environments
Data tools
Documentation
Support
   Maintenance
   Training
   eLearning
Packaging
License model
   Licensing method
   Attributes, rights, and conditions
Volume License program
   License tracking and compliance

### Practical Features of the EPD™ System

Practical features of the EPD™ System that make it outstanding for companies are:
A fully time dependent solution including time series of film build on the cathode at a user specified frequency
Simulation of electro paint deposition on 3D models of cathodes ranging from flat panels to frames—car, truck, etc,
Anodes of flat plates, semi-circular plates (super-cells) or cylindrical type
3D models of electro-coat tank assets re-used and managed by the system

The main purpose of computational simulation is to assist the decision making process by enabling different hypotheses to be investigated without resorting to physical trial-and-error testing. The EPD System is an example of a computational system for this purpose and as such, it is designed for a range of user groups with different needs, as depicted in Table 1 below.

TABLE 1

| Group | Requirements |
|---|---|
| Design- | Designers are responsible for positioning the access holes in |
| ers | the automobile. |
| | Designers use EPD to test different hypotheses by running |
| | ‘what-if’ scenarios to obtain optimized patterns of holes. |
| Plant | Plant operators are responsible for setting up the assembly |
| Operators | lines in paint shops. |
| | Plant Operators use EPD to experiment with different |
| | configurations of the tank, anodes, and cathodes to aid in |
| | trouble shooting and optimizing paint shop operations. |
| Virtual | Technical Specialists assist designers and plant operators, and |
| Manufac- | they perform troubleshooting when things go wrong. |
| turing | Technical specialists use EPD to test different hypotheses by |
| | running ‘what-if’ scenarios. |
| Research- | Researchers want the ability to experiment with paint |
| ers | properties, paint models, and parameters of the simulation. |
| | Researchers use EPD to run ‘what-if’ scenarios as a |
| | complement to their laboratory experiments. |

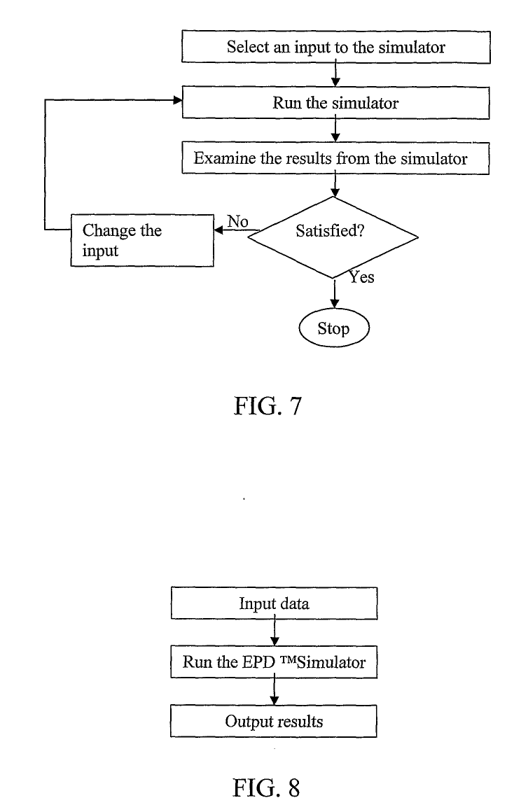

The common thread in all of these cases is the need to perform ‘what-if’ scenarios as depicted in the flow chart of FIG. 7.

Each time through the cycle, an (input, output) combination is generated. Each generated combination may be retained so as to contribute to the user's decision-making process. In an operational environment, especially one like an automotive manufacturer, decisions must be supported by a trail of activities that can be audited and scrutinized from a technical and financial perspective. The (input, output) combinations may be important contributors to this process. Therefore, some or all of the generated combinations may be retained and organized so they can be examined later. The EPD™ Project Manager subsystem may be used for this purpose.

Retaining scenarios is useful also because it allows a scenario to be re-played without re-running the simulator. Equally important though, especially for the requirements of designers mentioned above, is the ability to use a previous scenario to form the basis of a new one. 3D models of tanks and anodes can be reused for this purpose but so too can cathodes and the results from previous simulations.

For example, suppose a new design is based in part on a modification of a previous one for which EPD scenarios are available. Rather than beginning from scratch, the results and data from previous scenarios can help ‘jump-start’ the data preparation for the new design. It is often possible to use the results from previous simulations in order to make more insightful decisions (for example, of initial patterns of access holes) in order to steer the scenario cycle described above.

These are some of the novel features of the EPD System.

The general EPD™ Simulation Process

The EPD™ System implements the simulation strategy described in the previous sections. In broad terms, the general process is described by the three steps depicted in FIG. 8.

The system contains software tools to construct the input data:
A geometry that describes the cathode(s), anode(s), and tank for the simulation
Run time parameters specifying the duration of the simulation and the frequency of output for the time series

The EPD™ Simulator takes the input and applies boundary integral methods to solve the partial differential equations that describe the electro paint deposition process. These equations are advanced in time using a paint model. The EPD™ System is supplied with a basic paint model that can be used for experimental purposes and as the basis for developing a more accurate paint model, if and when one is desired.

Output results from the simulator include time series of film build, and other parameters, on the cathode at a user specified frequency. The system contains tools for viewing and analyzing the output.

The first and third steps above are described in the following subsections while the second step is described in detail under the section called the EPD™ Simulator.

### Input Data

Input data consists of two major items:
1. A geometry that describes the cathode(s), anode(s), and tank for the simulation, and;
2. Run time parameters specifying the duration of the simulation and the frequency of output for the time series.

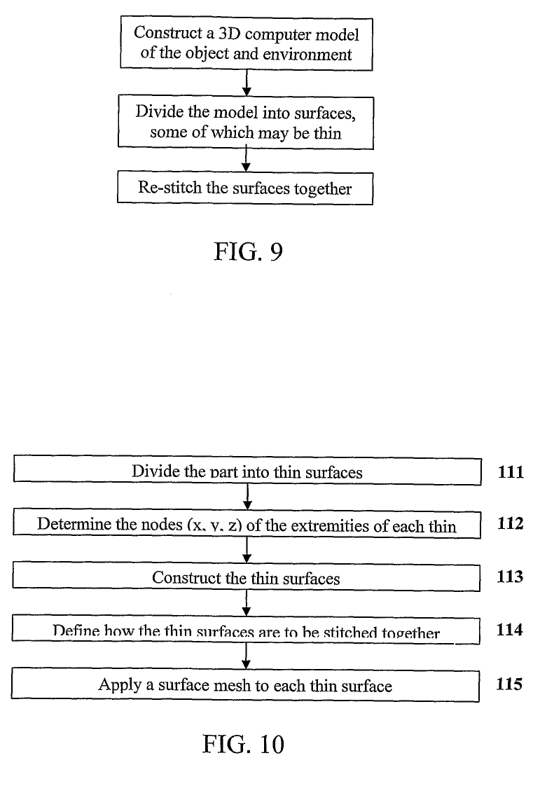

Item 1 is the most complicated and consists of the major steps depicted in the flow chart of FIG. 9, which is applicable to any object.

In the first step, the object refers to the cathodes upon which paint is to be deposited. The system allows for multiple cathodes in the input.

The environment refers to the electrocoat tank and the anodes contained in that tank.

The EPD™ System contains tools for constructing 3D computer models of these items using a library of graphical entities that includes nodes, edges, planes, and cylinders.

A summary of the steps used by the system in the construction of the input data for cathodes, tanks, and anodes is given in the next sections.

### Input—Cathodes

The major steps in constructing a 3D model of a part, whether the part is a single item like a rocker panel or a car frame, or multiple items such as two door frames, the procedure is the same and is depicted in FIG. 10.

At step 111, the part is divided into thin surfaces. From the given description of the part, identify all the places where more than one surface meets and apply the rule:
Extended planes of intersection divide a thick surface into a thin surface

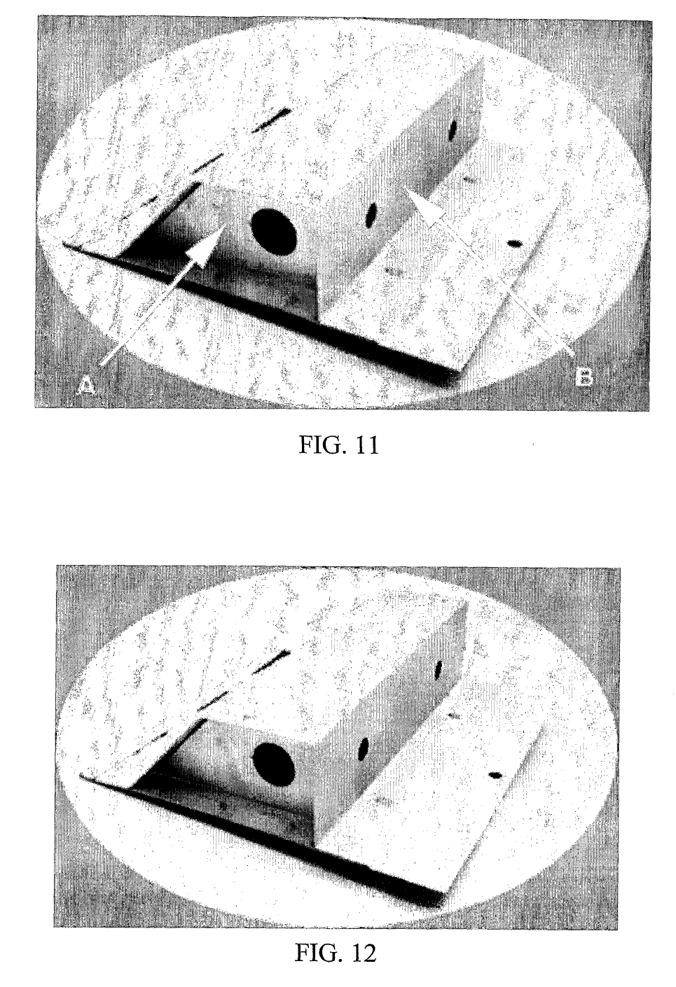

For example, consider the box depicted in FIG. 11 and in particular the end plane indicated by the white arrow marked A.

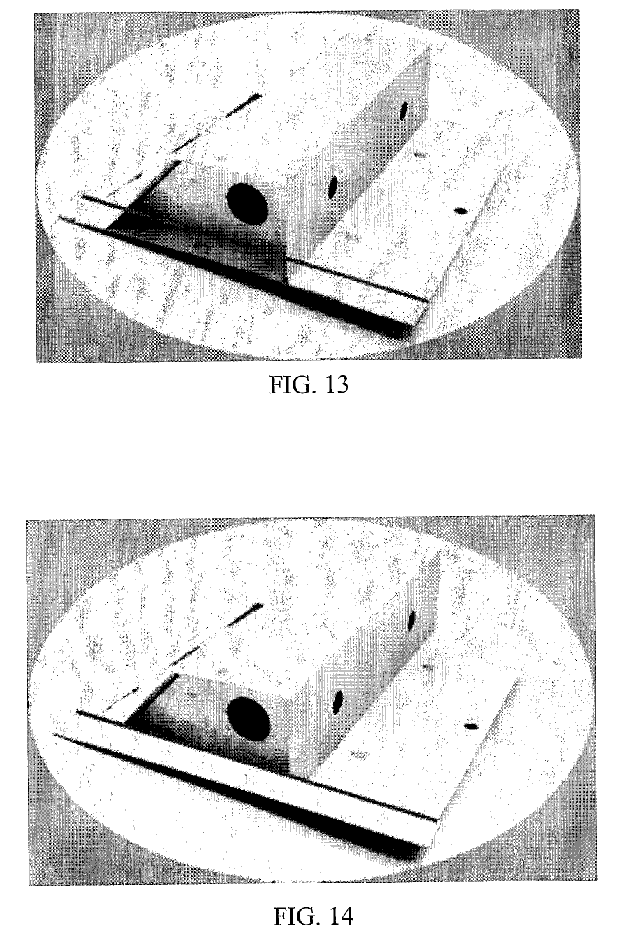

When extended, this plane can be thought of as a cutting plane that divides the bottom plate into two surfaces, as depicted in FIGS. 12, 13, and 14:

By treating the plane marked B in the same way, the bottom plate is divided into three surfaces as depicted in FIG. 15.

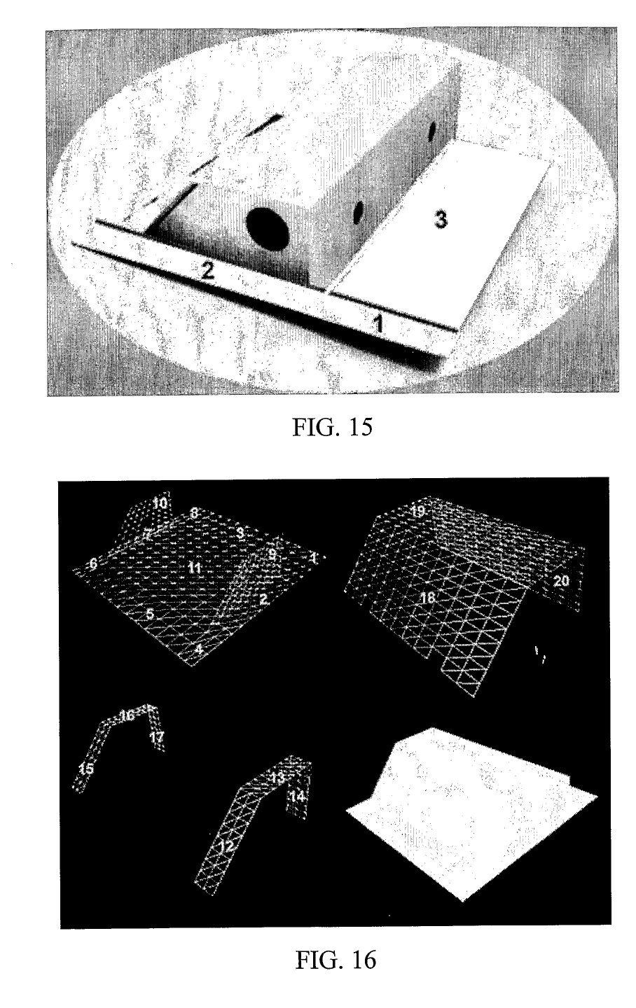

Continuing in this way with all the extended planes of intersection, divides the box into surfaces, 20 surfaces as depicted in FIG. 16.

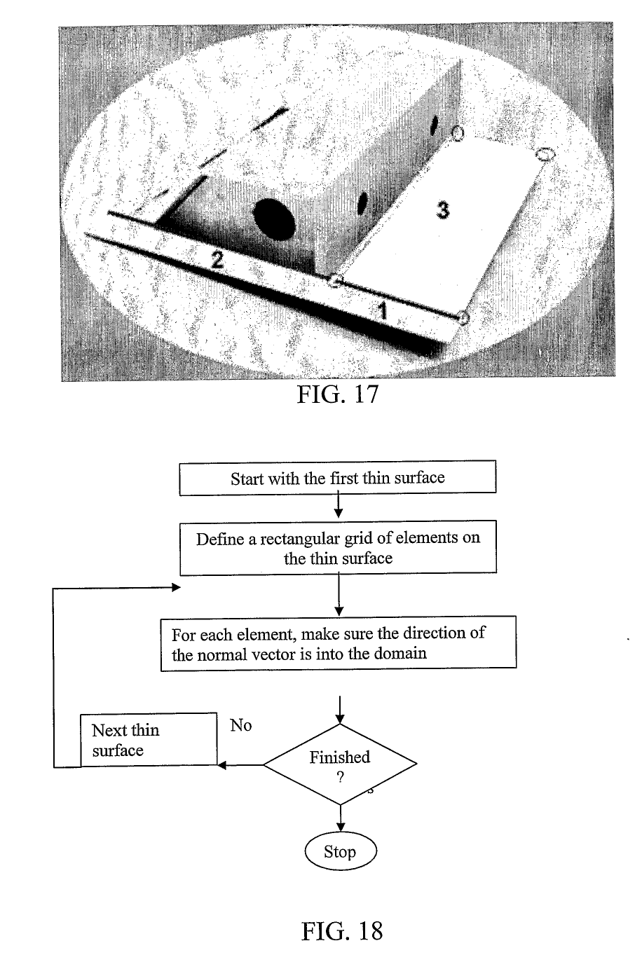

At step 112, the nodes (x, y, z) of the extremities of each thin surface are determined. From the description, determine the nodes (x, y, z) at the extremities of each surface, for example, the (x, y, z)-coordinates of the points circled in ed as depicted in FIG. 17.

At step 113, the 3D thin surfaces are constructed as depicted in the flow chart of FIG. 18. It should be noted, however, that the grid of elements is not limited to a rectangular grid, but also may include any other geometric shape useful for performing analysis.

At step 114, how the thin surfaces are to be stitched together is defined. During the phase of constructing a 3D thin surface model, note must be taken of the way the thin surfaces have to be stitched together again in order to form a unified, mathematically correct, model—as opposed to a collection of separate thin surfaces. The prescription for doing this stitching is described by an example.

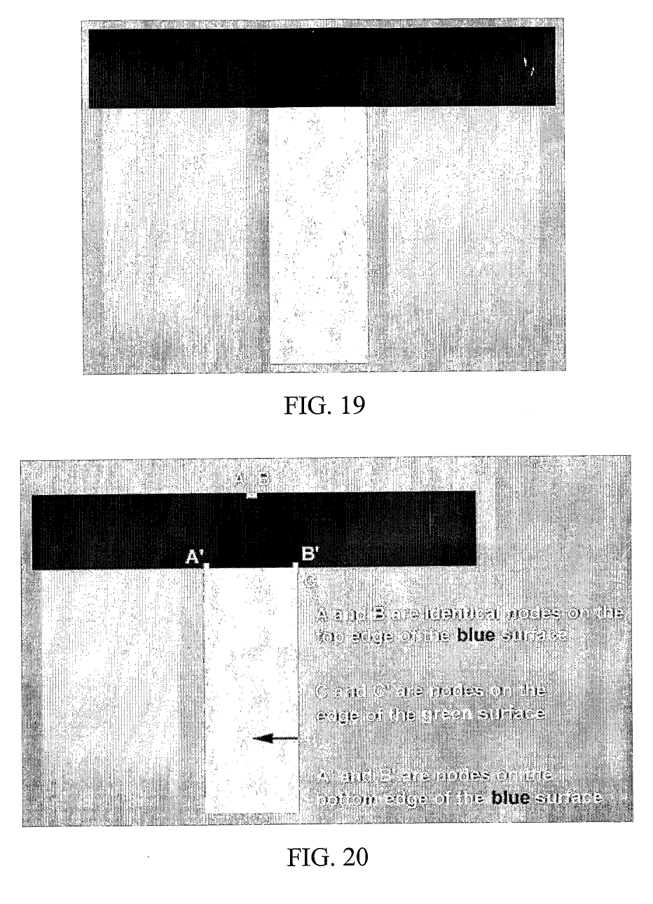

Consider the two thick surfaces as depicted in FIG. 19.

To explain how these surfaces are treated as thin surfaces, 6 nodes are introduced and defined as depicted in FIG. 20.

In FIG. 20, the arrows indicate the direction of the normal vectors to both surfaces.

The method requires the direction of the normal vectors to be continuous when moving from one surface to another.

In the limit as the thickness of the two surfaces is reduced, and taking into account the direction of the normal vectors, the 6 nodes collapse into the relationships:

A→B

B′→C

C′→A′

These relationships describe how the thin surfaces are stitched together to form a unified, mathematically correct, model.

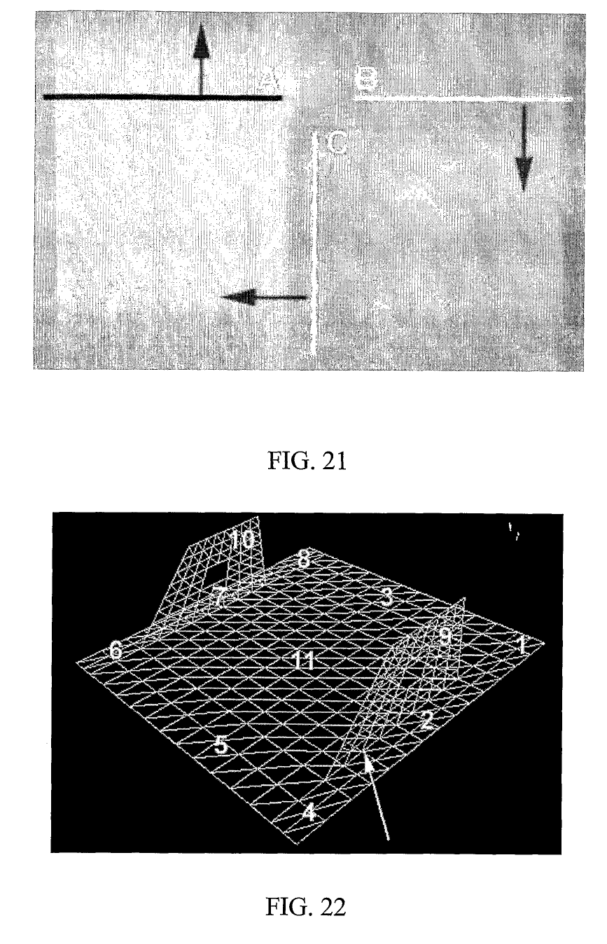

The two original thick surfaces have thus become three thin surfaces as depicted in FIG. 21.

The normal vectors (shown in red above) are continuous when moving clockwise from one thin surface to another.

The example above uses two thick surfaces that join to form a junction in the shape of a T. The same prescription, of introducing additional nodes and keeping track of the continuity of the normal vectors in the limit as the thickness is reduced, is used for other types of junctions as well.

### EXAMPLE

With respect to FIG. 22, consider the point indicated by the arrow.

The rule for joining the three surfaces, (9, 2, 11), at the indicated point is that the direction of the normal vectors on each of these surfaces must be continuous when moving from one surface to the other.

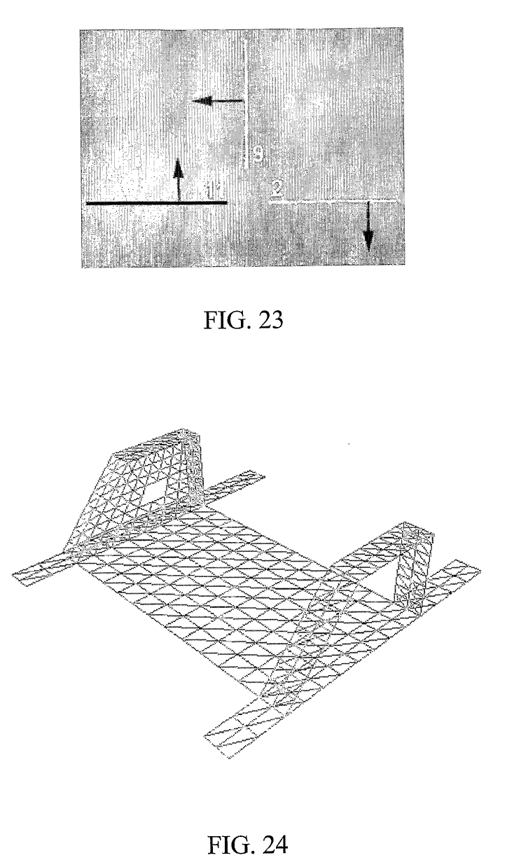

To apply the rule, it is necessary to know the directions of the normal vectors on each of the three surfaces. Suppose in this case that the normal directions are as depicted by the arrows in FIG. 23.

Because the directions are not continuous when moving from one surface to the other, either by moving clockwise or by moving counter-clockwise, this fact is recorded and passed to the boundary integral equations.

At each node of the junction, there are six nodes corresponding to the nodes A, B, C, A′, B′, and C′ defined in the prescription given in the previous section and these nodes satisfy the relationships:
A→B
B′→C
C′→A′

These relationships and the directions of the normal vectors on each of the surfaces specify how the surfaces 9, 2, and 11 must be joined at each node of the junction.

Returning to the flow chart of FIG. 10, at step 115 a surface mesh is applied to each thin surface. A surface mesh is a grid applied to the surface of the object. The boundary integral method provides the solution at each node of the grid. FIG. 24 depicts a surface mesh defined on 14 of the thin surfaces of the cathode example described above, where triangular elements are used for the discretization. It should be noted, however, that grid elements may be formed of any other shape useful for performing the analysis of the surfaces.

### In Practice

In one embodiment, cathodes are predominantly parts and frames of new car designs.

The EPD™ Project Manager database, described below, includes tools for registering cathodes used for previous EPD simulations along with their 3D models. The latter information is used by the EPD™ Grid Generator, described below, so 3D models do not have to be constructed from scratch every time a new simulation is performed with a modified cathode.

The EPD™ System contains graphical user interface controls enabling a user to select cathodes, and input cathode information, without having to understand underlying storage details and without having to understand the underlying programming language, e.g., the SQL language or SQL programming.

A feature of the EPD™ System is the ability of a user to perform ‘what-if’ scenarios to test hypotheses without having to perform physical experiments. In the case of cathodes, different patterns of access holes are investigated without building physical prototypes. The simulation of new designs based on previous ones are able to use previous simulation results in order to make more insightful selections of initial patterns to guide the scenario cycle previously described.

### Input—Tank

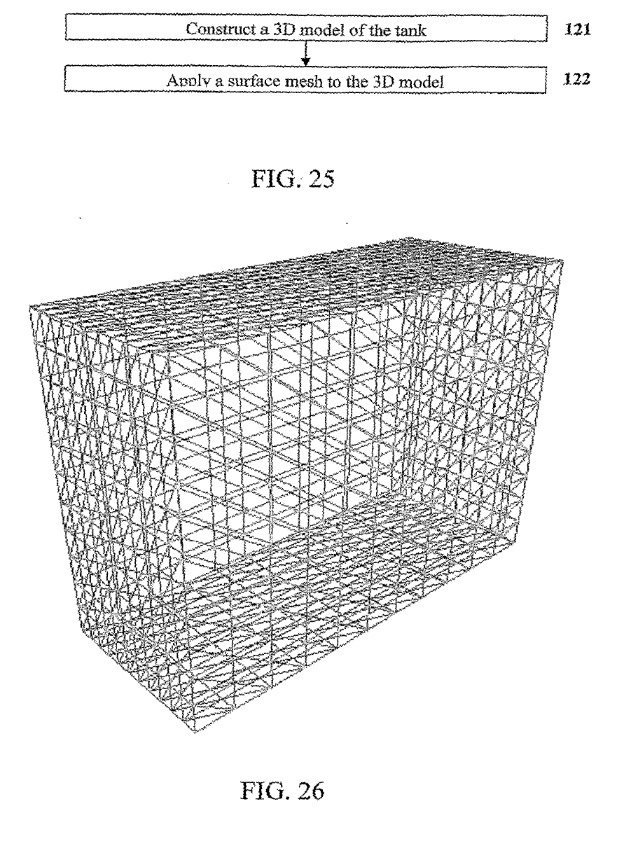

There are essentially two basic steps for using a tank as input as depicted in the flow chart of FIG. 25.

In step 121 and step 122, a 3D model of a tank is constructed in the same manner as the 3D model for a cathode, except there are no ‘junctions’ to deal with because tanks are just rectangular boxes. Consequently, a 3D model of the tank, such as the rendered version of the tank depicted in FIG. 26, consists of 6 planes with a surface mesh applied to each plane. It is to be understood that in alternate embodiments, a tank may be a different shape from rectangular and the above-described modeling technique with respect to cathodes may be applied.

### In Practice

Electrocoat tanks are approximately 90-105 feet long, although actual dimensions vary depending on the particular embodiment. The tanks are about 8-10 feet in depth and about 10 feet wide, depending on the manufacturing plant.

Tanks are a relatively static asset, i.e., the tank location and size does not change often once they have been installed, and therefore descriptive information about a tank is recorded with the certainty that it will not require frequent updates.

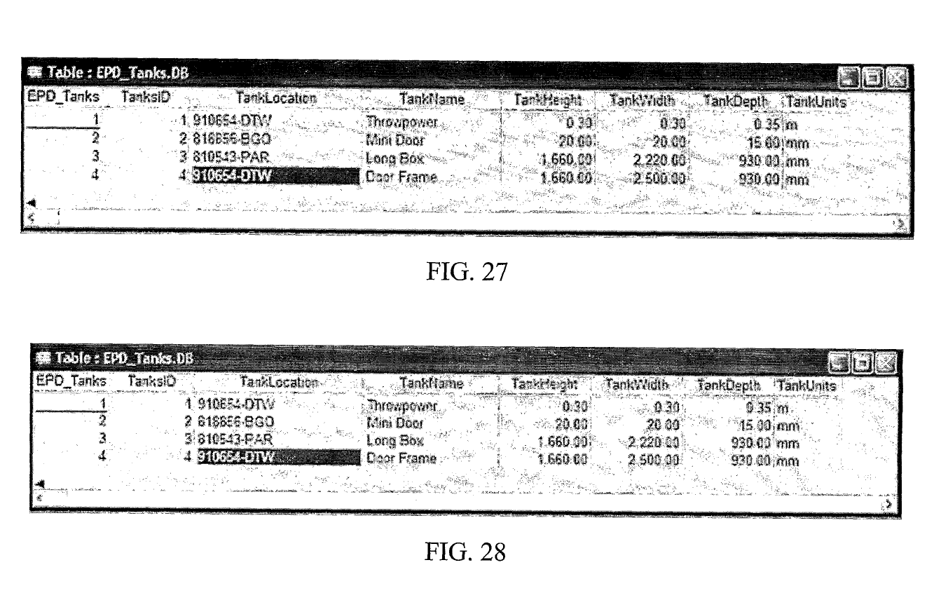

The EPD™ Project Manager database includes tools for registering the location and size of every electro-coat tank in use by a manufacturer. In addition, the 3D models of the tank as constructed by the EPD™ Grid Generator are referenced so they are not constructed every time a new simulation is performed using the same tank. The database allows users to select tanks by name or physical location without having to remember detailed information about the tank. FIGS. 27 and 28 depict screenshots of an interface displaying tank information to a user.

The EPD™ System contains graphical user interface controls enabling the user to select tanks, and input tank information, without having to understand underlying storage details and without having to understand the underlying programming language, e.g., the SQL language or SQL programming.

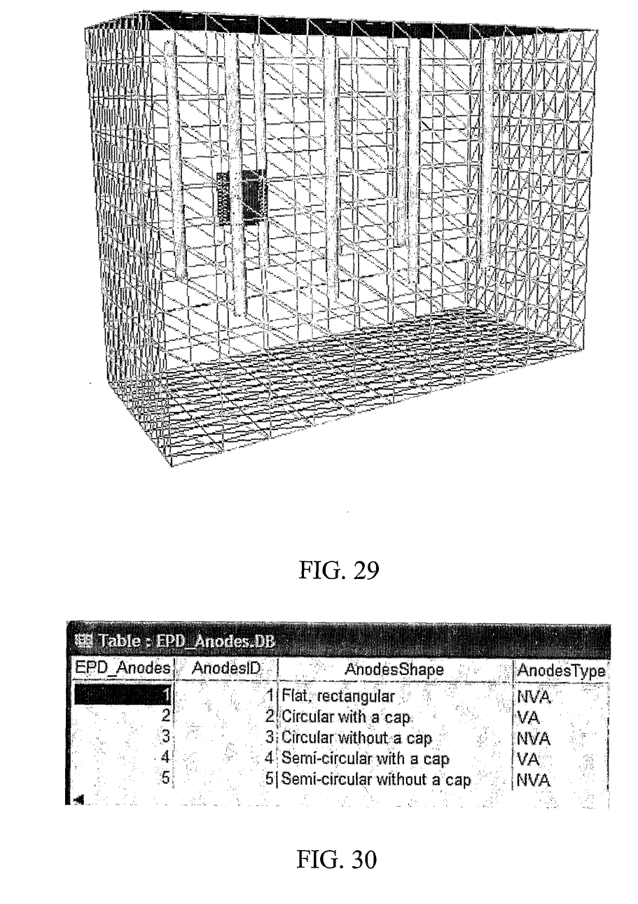

Tanks include arrangements of anodes. FIG. 29 depicts an example of a 3D model of a tank having eight cylindrical anodes and a cathode. The tank model is drawn in a way enabling visualization of the anodes inside the tank and the computational mesh for the particular simulation.

Stored tank information includes information about the anodes physically installed in the tank. For example, a paint plant in Belgium may have an electrocoat tank having 60 cylindrical anodes of a certain size and the particular tank configuration information is stored in the database. Consequently, a user selection of a particular tank for a simulation retrieves the associated anode information.

A novel feature of the EPD™ System is a the user can perform ‘what-if’ scenarios to test hypotheses without having to perform physical experiments. In the case of tanks, typical scenarios are of the form: What happens in the tank if one or more anodes are broken? What happens to the power consumption and anode lifetime if we replace cylindrical anodes with semi-circular ones? Scenarios of this type require changes to the configuration of the tank and the changes are accounted for by functionality supplied in the EPD™ Grid Generator.

Associated with each 3D tank model is the concept of a preferred computational grid for the particular tank based on the intended simulation. A preferred computational grid, dependent on the size and shape of the grid elements, is sufficiently fine to resolve details of the physical and mathematical processes. For example, with respect to the example depicted in FIG. 50, when the top and middle surface distance decreases, the mesh needs to be more refined in order to handle near-singularities. More refinements means more nodes and more equations. If the nodes describe shapes which are long and thin, then more singularities are introduced and thus, the shape of the elements of the grid are an important factor. For example, in FIG. 29 the computational grid is appropriate for the cathode and anode distribution depicted. If either of these items change, then the computational grid needs to be changed in order to obtain a desired level of accuracy from the simulation. Preferred grids for each tank are also available for selection by a user through the graphical user interface of the EPD™ System.

### Input—Anodes

Anodes are designated as having a volume (VA) or as not having a volume (NVA). Non-volume anodes are treated as thin-surfaces whereas volume anodes are not. Volume anodes are treated as thick surfaces. For example, FIG. 30 depicts a screenshot of a user interface display of classification of anodes by shape and type.

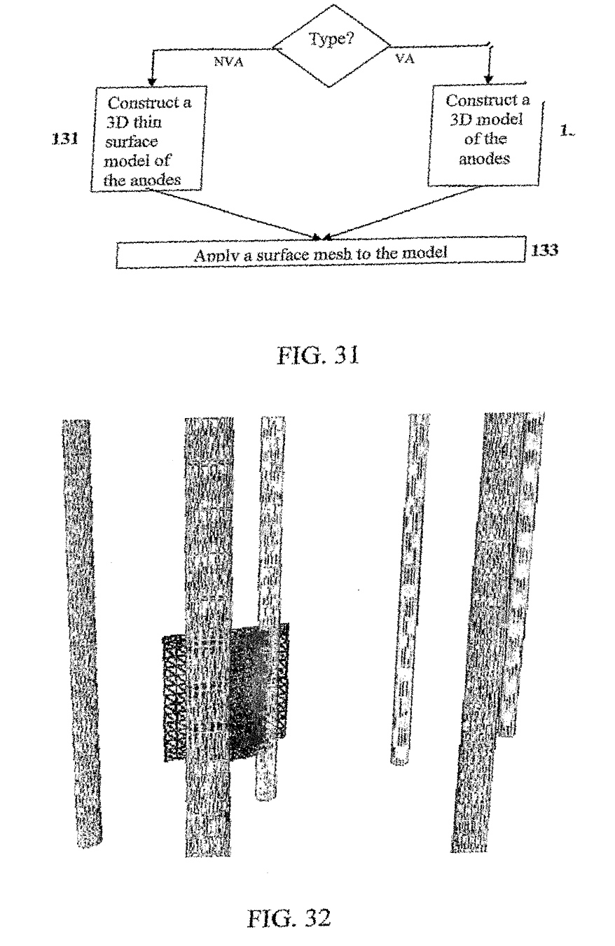

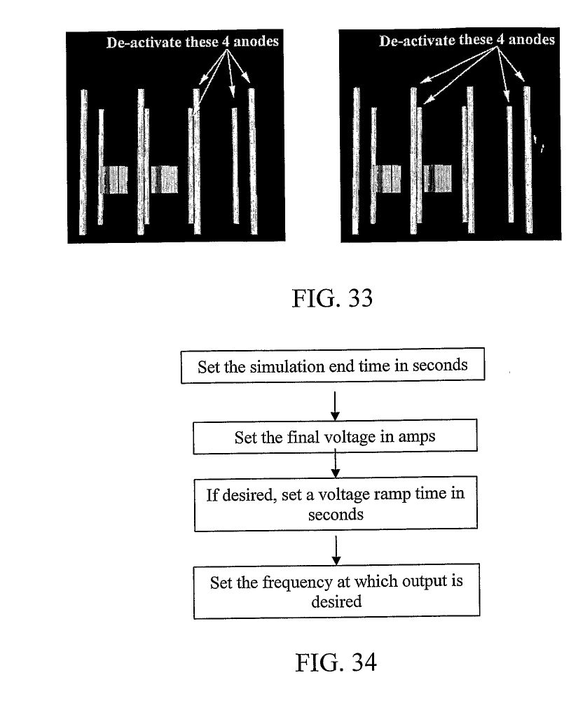

FIG. 31 depicts a flow chart of a determination of an anode designation. Following the flow from steps 131 to 133, a 3D thin surface model of the anodes is constructed and a surface mesh applied.

Non-volume anodes with thin surfaces are constructed and meshed in exactly the same way as 3D models for a cathode, using the procedures described above, implemented in the EPD™ Grid Generator.

Following the flow from steps 132 to 133, a 3D model of the anodes is constructed. 3D models of anodes not having any thin surfaces are also constructed using the EPD™ Grid Generator, which takes account of the fact that there are no thin surfaces to consider. In such an instance, for example, Finite Element Analysis may be utilized to model the anode.

### In Practice

The collection of 3D anode models of used by a manufacturer is organized and referenced by a standard SQL database of the EPD™ Project Manager. The database allows users to select anodes by name or physical location without having to remember detailed information about the anode.

The EPD™ System includes graphical user interface controls enabling a user to select anodes, and input anode information, without having to understand underlying storage details and without having to understand the underlying programming language, e.g., the SQL language or SQL programming.

Associated with each 3D model of an anode is a preferred computational grid for the particular anode type based on the intended simulation. The solution of the boundary integral equations at t=0 is an important part of the iterative process described in the flow chart of FIG. 1. Because the solution depends on the boundary of the domain, which includes the anodes as well as the cathodes, the computational grid on the anodes must be sufficiently fine to resolve details of the physical and mathematical processes at t=0 and at all subsequent values of t.

It may be necessary to change the computational grid in order to obtain a desired level of accuracy from a particular simulation. Preferred grids for each type of anode are also available for selection by a user through a graphical user interface.

To accommodate the type of ‘what-if’ scenarios mentioned in the previous section about the tank, namely: “What happens in the tank if one or more anodes are broken? What happens to the power consumption and anode lifetime if we replace cylindrical anodes with semi-circular ones?” Anodes are designated as being either active or not. For example, FIGS. 31a and 31b depict two possible situations.

Situations warranting this type of treatment occur often in practice because anodes break and dissolve in the tank. Functionality for manipulating anodes, and their configurations, is supplied in the EPD™ Grid Generator.

### Input—Runtime Parameters

Runtime parameters determine the tasks of the EPD™ Simulation for a particular experiment. An electro-paint deposition process requires an automotive part to be immersed in electrocoat paint for an amount of time, e.g., usually no greater than four (4) minutes. The simulation time corresponds to the part immersion time.

In practice, a voltage ramp specifies the time at which the final voltage is attained. For example, a voltage ramp of 10 seconds means that the final voltage will be attained after 10 seconds immersion in the paint.

### Output—Results

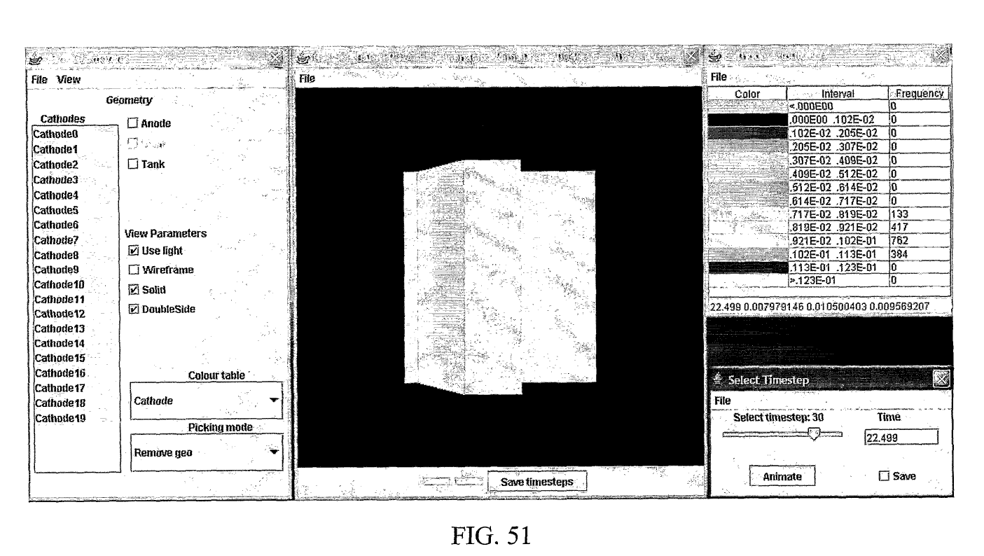

The output from the EPD™ Simulator is generated automatically and consists of at least the items as depicted in Table 2 below. FIG. 51 depicts a screenshot of a user interface display of a plot of data at time t—22.5 seconds.

TABLE 2
Item

Time series of film build on the cathode(s)
Time series of potential on the cathode(s)
Time series of current distribution on the cathode(s)
Time series of iterations taken
The series of time steps used in time stepping

The EPD™ Project Manager manages ED output data. The EPD interface includes controls enabling a user to access and analyze output data using the EPD™ Viewer.

### The EPD™ Simulator

### Basic Mathematical Model

(a) The rate at which paint deposits on a cathode is a function of the local current density j:

d/dt(L_{F}(t))=β*j
L_{F} is the thickness of the paint and β is the current efficiency.
(b) The current density j, as a function of position over the cathode surface, is obtained from the normal derivative of the electric potential Φ, which is determined by solving the 3D Laplace equation ∇²Φ=0, subject to boundary conditions.
(c) No boundary values are specified on the cathode but there is a relationship between surface potential and current density. The physical model used for the paint process specifies the relationship, which, in general, depends upon the paint properties and other physical factors.

Characteristics of the simulation problem include:
Complicated car frame geometry and anode configurations. Car frames are composed of thin metal and modeled as infinitely thin crack geometry.
Only surface quantities are needed (the current density j is required as a function of position over the cathode surface), i.e. no volume solution required.
Nonlinear (Robin-type) boundary conditions (C) require current and potential on both sides of the crack geometry, i.e. on both sides of the thin metal.

### Basic Numerical Method

In order to treat thin parts, boundary integral equations for surface potential and surface flux are employed:

The equation for the surface potential is:

$$φ ( P ) + {\int }_{Σ} φ ( Q ) \frac{\partial G}{\partial n} ( P , Q ) d Q = {\int }_{Σ} G ( P , Q ) \frac{\partial φ}{\partial n} ( Q ) d Q$$

The equation for the surface flux is:

$$\frac{\partial φ ( P )}{\partial N} + {\int }_{Σ} φ ( Q ) \frac{{\partial }^{2} G}{\partial N \partial n} ( P , Q ) d Q = {\int }_{Σ} \frac{\partial φ}{\partial n} ( P , Q ) \frac{\partial φ}{\partial n} ( Q ) d Q$$

The local current density is j=−κ∂Φ/∂n, where κ is the paint conductivity. In the integral equation approach the normal derivative of the electric potential Φ, is calculated directly, i.e., without numerical differentiation.
For this problem, no volume solution is required, only surface quantities are needed. Therefore, the boundary integral method is entirely appropriate.
The integral equations are approximated using a Galerkin method. This allows for a straightforward and mathematically correct analysis of the hypersingular flux equation essential for treating thin parts as a single surface. Suitable accurate and efficient Galerkin singular integration algorithms based upon analytic integration include those developed by Gray, see Reference 1 below, and are hereby incorporated by reference.
Additionally, a time stepping algorithm, e.g., using a Runge-Kutta method, is used to track the time evolution of the paint distribution.

### Mathematical Formulation

The mathematical formulation of the electro painting problem, solved by the EPD™ Simulator, is summarized in the following equation:

Laplace equation for the electric potential: w(z, y, z)

$$\frac{{\partial }^{2} φ}{\partial {x}^{2}} + \frac{{\partial }^{2} φ}{\partial {y}^{2}} + \frac{{\partial }^{2} φ}{\partial {z}^{2}} = 0$$

Boundary conditions
   Tank walls:

$$zero current ℐ = κ \frac{\partial o}{\partial n} = κ ∇ φ \cdot n$$

Anode: φ=applied voltage
Car part (cathode)

*t=0; φ=0

*t<0; φ=F(I_{c}, D . . . . ) Paint model
Solve for cathode current I_{c}
   Deposition proportional to I_{c}

Specifically, the three-dimensional Laplace equation for the electric potential is solved subject to boundary conditions on a tank, an anode, and a cathode.

### Paint Model

When time t is greater than zero, the electric potential Φ is given by a paint model F, which is a mathematical statement of how paint deposits on the surface of the cathode as time passes. The model approximates the physical and chemical reactions involved in the process and therefore depends on parameters reflecting the reactions occurring on the surface of the cathode while submerged in the tank. Many manufacturers have their own ideas about the parameters to be included in the paint model and most are proprietary. This situation does not detract from the use of the EPD™ System because any paint model F specifying a relationship between surface potential and current density may be used.

Because the EPD™ System is independent of any particular paint model, a non-proprietary one, Φ=F(I) depending only on the current I, is supplied with the system as in the following equations:

$$\begin{matrix}φ = β I \\ I = {σ}_{b} \frac{\partial φ}{\partial n} \\ β = \frac{{P}_{T}}{{σ}_{p} ( 1 - \frac{{P}_{T}}{h ∞} )}\end{matrix}$$

$$\frac{d}{d t} {P}_{T} ( t ) = {{I}_{ɛ \int \int } ( I - {I}_{min} )}_{0}$$

P_{T}=Pᵣ(X,t) calculated paint thickness
σₚ 5.07F-7 pore conductivity
h_{χ} 5.16E-5 maximum possible paint thickness
Iₘᵢₙ 1.04 minimum current for deposition
σ_{b} 0.15 both conductivity
I_{cff} 3.14E-8 current efficiency

The model is used for experimental purposes and as the basis for developing a more accurate paint model, if desired.

### Boundary Integral Equations

The numerical formulation of the electro painting problem, solved by the EPD™ Simulator, is summarized in the following equations:

$$φ ( P ) + {\int }_{\sum } \{ φ ( Q ) \frac{\partial G}{\partial n} ( P , Q ) - \frac{\partial φ}{\partial n} ( Q ) G ( P , Q ) \} d Q = 0$$

$$\frac{\partial φ}{\partial N} ( P ) + {\int }_{\sum } \{ φ ( Q ) \frac{{\partial }^{2} G}{\partial N \partial n} ( P , Q ) - \frac{\partial φ}{\partial n} ( Q ) \frac{\partial G}{\partial N} ( P , Q ) \} d Q = 0$$

$$G ( P , Q ) = \frac{1}{4 π r}$$

In the above equations, n=n(Q), N=N(P) denote the outward unit normal on the boundary surface Σ, and P and Q are points on Σ, G(P, Q) is the Green's function, and r is the distance between P and Q.

Specifically, Laplace's equation is transformed into two boundary integral equations, one for surface potential and one for surface flux. The equation for surface flux is called a hypersingular equation because of the second order derivative term in that equation. Accurate methods for evaluating this term have been developed by Gray for the case when the Galerkin method, more fully described in Reference 3 below, is used to solve the boundary integral equations.

In the EPD™ Simulator, the Galerkin method is applied according to standard practice where the boundary potential and flux are approximated in terms of values at element nodes Qj and shape functions ψ₍((Q) as in the following equations:

$$φ ( Q ) = {\sum }_{j} φ ( {Q}_{j} ) {φ}_{j} ( Q ) . \\ \frac{\partial φ}{\partial n} ( Q ) = {\sum }_{j} \frac{\partial φ}{\partial n} ( {Q}_{j} ) {φ}_{j} ( Q )$$

Singular integrals are present because the Green's function G(P, Q) and its derivatives diverge as Q→P. In a Galerkin approximation, the integration of these functions is carried out with respect to both P and Q, and in terms of the numerical implementation, this means that integrations are required for every pair of elements {E_{P}, E_{Q}}. An integral is therefore singular if the elements are coincident (E_{P}=E_{Q}) or they are adjacent, sharing either an edge or a vertex. For these situations, a combination of numerical and analytic integration is employed and implemented in the EPD™Simulator.

The boundary integral equations are reduced to a finite system of linear equations by approximating the surface Σ in terms of the elements defined by the Qⱼ nodal points, and then interpolating the surface potential and flux in terms of values at these nodes. This results in a matrix system according to the following equation:

H[φ]=H[I]

Where H and G are square matrices and [Φ] and [I] are column vectors of the nodal values of potential and current. Taking into account the known boundary conditions, the linear equations are solved simultaneously with the relationship between surface potential and current density provided by the paint model.

### The EPD™Simulator Implements the Process.

Time Evolution

The present inventors have developed novel software and methods for processes where knowledge of what happens at arbitrary instances in time is important. For example, a technician might like to know how much paint has been deposited on a car part after the part has been submerged in the paint for 35 seconds. Numerical methods for this purpose are referred to as time-dependent methods and involve the solution of a set of ordinary differential equations describing the time evolution of the process according to a prescribed model, for example the paint model described in the previous section.

### Extensions

As discussed previously, the present embodiments may include thermal modeling and crack propagation, as well as electro-deposition modeling.

Additionally, the present simulation is able to treat more general problems that include the following parameters:
1. Geometry—a numerical geometry, including thin surfaces where necessary, on which the simulation is to be conducted.
2. A mathematical model of the physical process to be simulated.
3. Time evolution—a method for computing the evolution of the physical process as a function of time.

Because the underlying numerical methods used for solving the partial differential equations are boundary element methods (BEM), the mathematical model in problem 2 identified above may be formatted for a solution by BEM.

In an embodiment, the above-described methods are applied to simulate thermal properties, e.g., dryness of applied paint during baking. The embodiment predicts a dryness of a coating on an object using an object model using a thin crack geometry representation of a portion of the object or the coating. Additionally, an applicable boundary condition model of a predetermined thermal process applied to the object is used. A simulator module simulates application of the predetermined thermal process to the object by applying the boundary condition model to the object model and output a predicted amount of dryness of the coating on the object.

### Computational Environments

The EPD™ Simulator requires a computational environment capable of handling the complexities of simulating a cathode, an anode, and a tank.

In this context, complexity relates to the physical features having an impact on the accuracy of the numerical methods described above in the Basic numerical method section. For example, sufficient accuracy may require use of many elements in the surface mesh applied to the cathode, anode, or tank and impose conditions on the power and memory requirements of the computational environment. For this reason, two versions of the EPD™ Simulator are provided.

### Stand-Alone Version

The stand-alone version executes on a single computer, such as a laptop, desktop, workstation, or supercomputer.

In an embodiment, the stand-alone version is available in four memory models: Small, Medium, Large, and Huge having the capabilities depicted in Table 3. Although four memory models are described, these are only exemplary in nature and other embodiments may have more or less numbers of models.

TABLE 3

| Memory model | Will handle geometry with |
|---|---|
| Small | Less than 4001 elements |
| Medium | Less than 11001 elements |
| Large | Less than 500,001 |
| | elements |
| Huge | Less than 5,000,001 |

A division based on memory models enables software tools to be written so the resources required for the simulator to execute a particular geometry are automatically identified. The EPD™ Profiler is a tool for this purpose.

### Parallel Version

Unlike the stand-alone version of the simulator, the parallel version applies multiple processors to execute a single simulation. In alternate embodiments, multiple processors are housed in a single box, contained in a cluster, or are positioned in separate machines distributed worldwide.

### The EPD™ Computational Grid

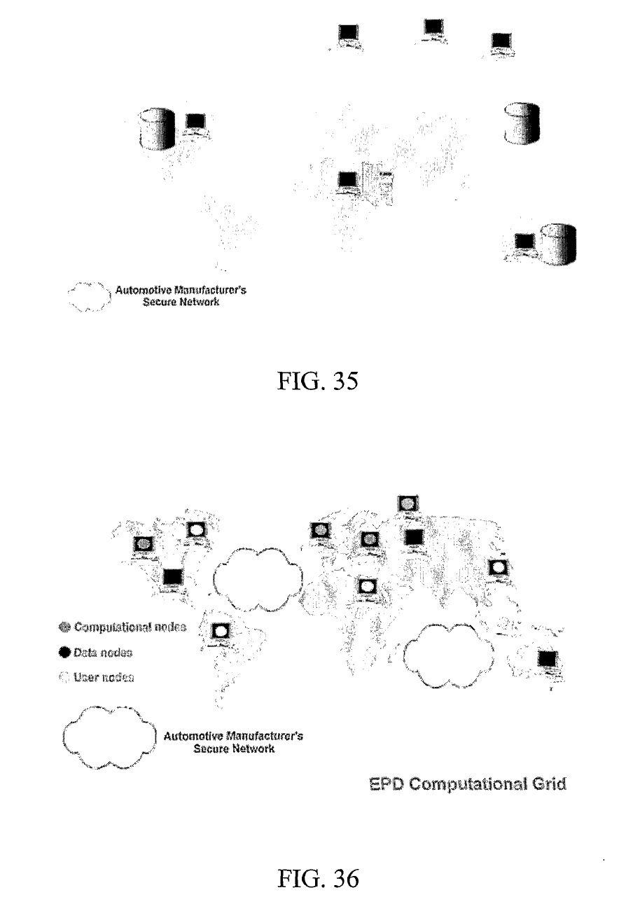

In one embodiment, companies using the EPD™ System have global worldwide activities. For example, one large company may have operations in numerous countries resulting in thousands of computers and workstations worldwide, as depicted in FIG. 35. In other embodiments, smaller networks of resources may be utilized with the present system.

The EPD™ System provides software tools for a company to assign a subset of the total computing resources to EPD. The resulting assignment is called the EPD™ Computational Grid.

The EPD™ Computational Grid combines an assigned subset of a company's computing resources, irrespective of resource location, into a virtual network available for EPD computations. In practice, the virtual network is a combination of several physical networks, but this fact is transparent to a user.

The set of computing resources in the EPD™ Computational Grid is divided logically into computational nodes, data nodes, and user nodes as depicted in FIG. 36.

A user at a computer system, e.g., computer system 5500 (FIG. 55), in one location causes execution of simulations on computer systems in other locations connected by a communication network.

The combined collection of resources, e.g., computer systems, assigned for performing simulations is called the EPD™ Computational Grid. The number of computer systems in the Grid does not limit the number of executable simulations as the system has a queuing mechanism for managing the submission of jobs based on computer system availability. Thus, a Grid can be set up with just one computer system as the computational resource.

### Computational Nodes

The individual computational resources assigned for executing simulations are called computational nodes and are treated as dynamic in the sense that they come and go according to, for example, business requirements. Computational nodes execute the EPD™ Simulator and, depending on a particular embodiment, may be standalone computers, clusters of computers, parallel computers, or any combination of these configurations. They can also be the spare capacity from computers not in use at night or at other off-peak times.

When a computational node is already in use for back-office, e-mail, or other applications, or when the node is down for maintenance, then the node notifies the Grid that it is not available for computational use. Otherwise, the node is part of the computational pool and can be assigned scenarios to execute.

The node informs the Grid of its availability, in a similar way to factory workers when they clock on and off work. Likewise, when a node clocks on for work it is expected to remain until it is time to “go” or unless something goes wrong.

### Data Nodes

Data nodes are resources containing input and output data from the EPD™Simulator.

### User Nodes

User nodes are resources executing other tools of the EPD™ System, e.g., some data nodes only require tools to view and analyze results from an EPD simulation. The tools execute on data nodes which are not as powerful as computational nodes.

### Operation

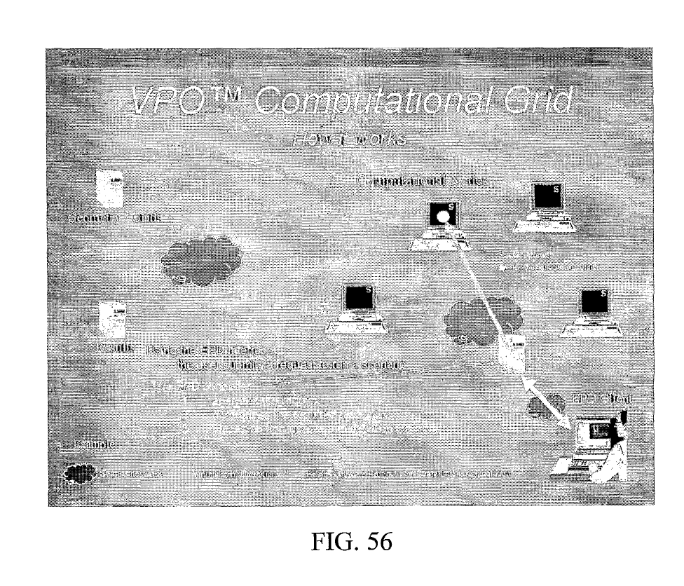

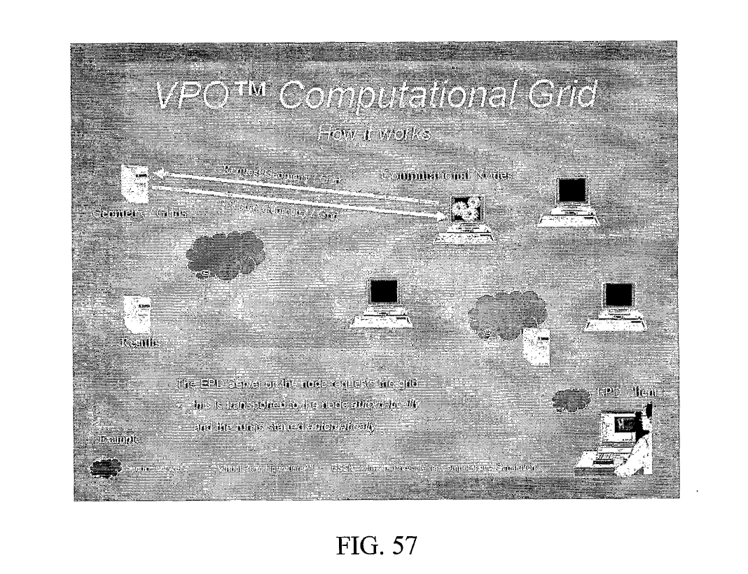

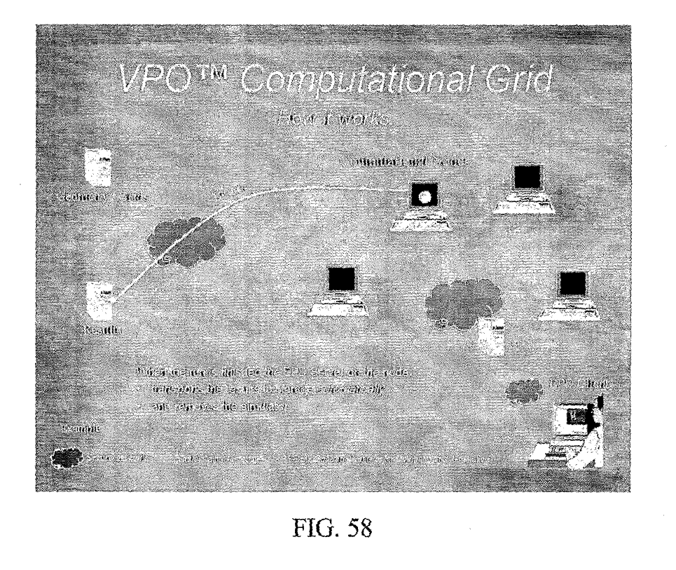

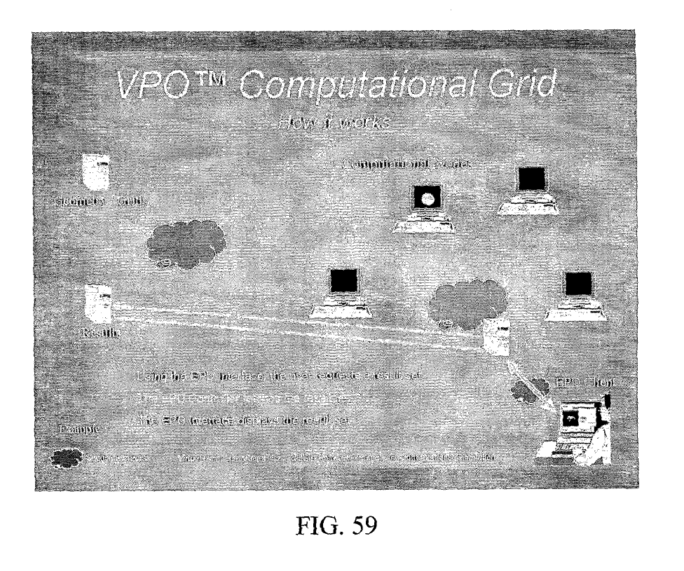

FIGS. 56-59 depict operation of a workflow of computational resources according to an embodiment. As depicted in FIG. 56, an EPD™ Controller receives a request from a user, i.e., an EPD Client, for execution of a simulation scenario. If the user submits a scenario requiring more computational resources than the node selected for execution by the user, the EPD Controller takes appropriate action as described below. Otherwise, the EPD Controller places an appropriate simulator on the user-selected node.

Simulators are placed on the computational node by the EPD Controller. In an embodiment, the computational nodes do not have any simulators pre-installed on them. Not pre-installing simulators on the nodes greatly reduces the effort to install and maintain nodes. In other embodiments, the simulators are pre-installed on the computational nodes.

To add a node to the computational network requires adding a small EPD Server to the node. When the computational node is available for use with the EPD Grid, the node notifies the EPD Controller automatically. Likewise, if the node is not available for some reason, then the EPD Controller determines this fact automatically.

The Grid incorporates fail-safe operational features to take account of “when things go wrong” in order to minimize the impact of failures. If a failure occurs, the user is not affected because the system is capable of resolving issues independent of the user. Typical situations of failure include:
If a computational node fails, the system holds jobs until the node comes back on line again; and
If a computational node fails, maintenance may require that the node be placed offline until fixed and tested.

### Dynamic Allocation of Simulators

As described above according to an embodiment, the computational nodes of the Grid do not have permanently installed simulators. If a simulator is required, the simulator is placed on the appropriate computational node by the EPD controller. After execution, the simulator is removed from the computational node according to a set of well defined procedures.

EPD simulators are stored and managed by a database on the EPD Controller. In an embodiment, the database maintains an overview of the licensing agreements that are required. In other embodiments, licensing is managed by separate applications and/or computer systems.

This arrangement is designed to provide maximum flexibility for usage, maintenance, and support. In particular, because simulators are not node locked to a particular computer, computational nodes can be re-assigned without requiring licensing changes. Adding new computational nodes is equally straightforward.

### Software Tools of the EPD™ Computational Grid

The EPD™ Computational Grid includes software tools for using the grid in an automatic manner.

### The EPD™ Profiler

The EPD™ Profiler is software for automatically determining the profile of a resource required for executing an EPD simulation.

For example, a company may have 50 workstations, in different countries, but only 10 have enough memory to execute a particular simulation. The EPD™ Profiler automatically determines this information based on evaluation of input concerning workstation capability and the underlying knowledge of the simulation requirements.

### The EPD™ Scheduler

The EPD™ Scheduler automatically determines which resources in the profile are available to execute the simulation within a time requested by a user. If more than one resource is available then the EPD™ Scheduler decides which one to use and automatically schedules the resource to execute the simulation.

For instance, of 10 resources available in the above example, 4 are located in North America, 3 are in Europe, and the remaining 3 are in Japan. Resources already used or scheduled to be used before the present simulation would be finished are eliminated as possible resources. Of the remaining resources, the EPD™ Scheduler decides which is appropriate to use based on the company's internal pricing strategy for using each resource, i.e., the less costly alternative is chosen and the simulation scheduled on the particular resource.

### The EPD™ Executive

The EPD™ Executive starts the simulation on the chosen resource, monitors progress, and handles placement and storage of the results.

### Data Tools

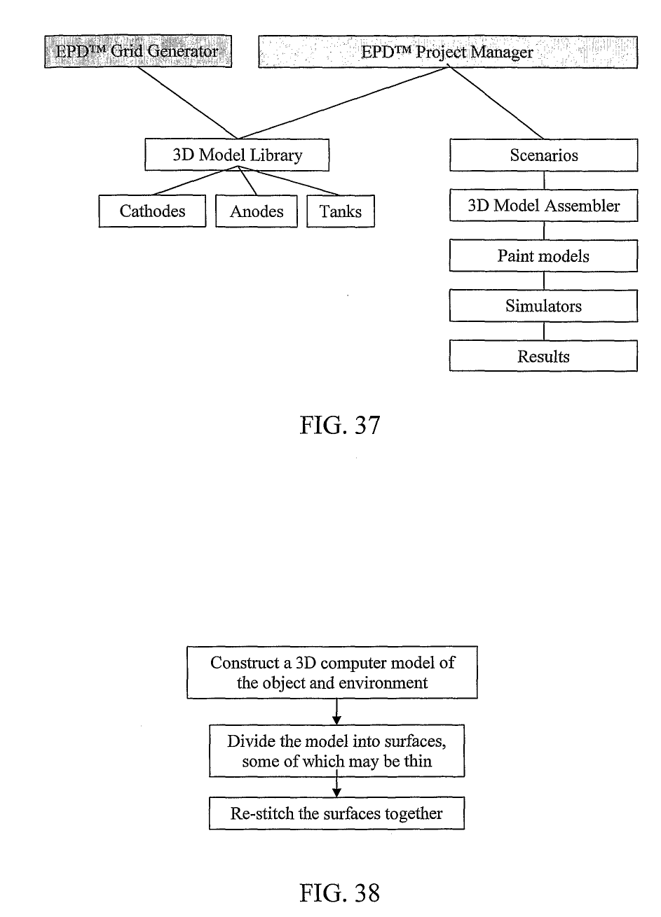

A high level overview of the basic functionality of one embodiment of the EPD™ System is depicted in FIG. 37. The EPD™ System consists of software subsystems, which combined provide the functionality required for using EPD in operational environments.

The present subsystems are shown in the following table.

TABLE 4

| Name | Purpose |
|---|---|
| EPD ™ Project | To manage all data related to a project |
| Manager | |
| EPD ™ Model | To manage paint models and their associated |
| Administrator | parameters |
| EPD ™ Facility | To manage 3D models of a company's |
| Administrator | electrocoat tanks |
| EPD ™ Grid | To construct a 3D model of the object to be |
| Generator - Model | simulated according to the thin-surface |
| Builder | requirements of EPD |
| EPD ™ Grid | To construct a surface mesh on a thin-surface |
| Generator - Surface | 3D model |
| Mesh Generator | |
| EPD ™ Tank | To manage and optimize the anodes in an |
| Optimizer | electrocoat tank |
| EPD ™ Viewer | To display and analyze the input and output |
| | from the EPD simulator |
| EPD ™ Profiler | To produce a profile of the computer resources |
| | required to run a particular EPD simulation |
| EPD ™ Scheduler | To schedule the necessary resources for |
| | running an EPD simulation |
| EPD ™ Executive | To start a simulation, monitor its progress, and |
| | handle the placement and storage of the results. |

The EPD Profiler, Scheduler, and Executive have been described above. Each of the remaining subsystems are now described below.

### EPD™ Grid Generator

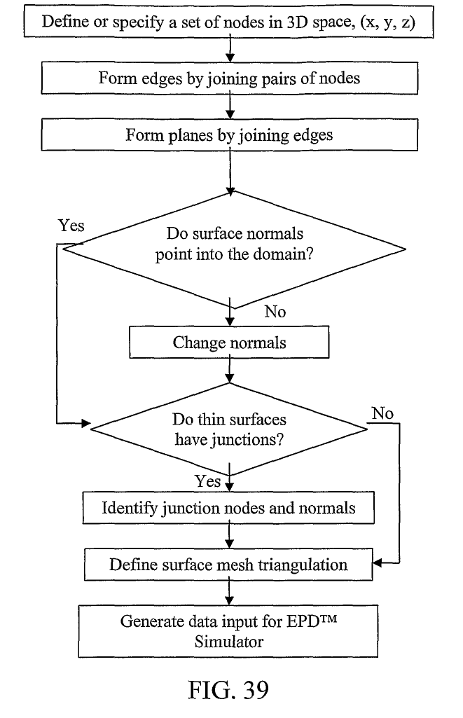

FIG. 38 is a flow chart depicting the three major functions of the EPD™ Grid Generator. The EPD™ Grid Generator implements the functionality by providing tools for the following steps (depicted in the flow chart of FIG. 39) conducted interactively by a user at a computer. The EPD™ Grid Generator generates a markup-language-based file, e.g., XML, for storing the generated model.

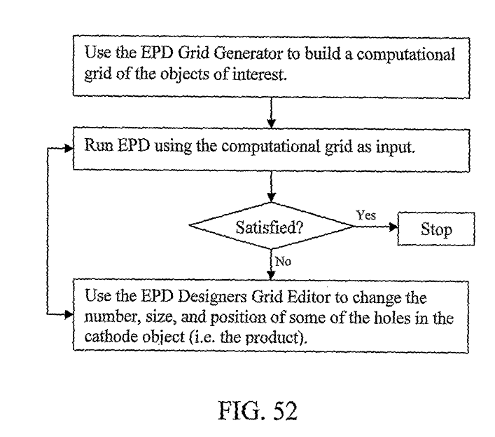

A sub-system of the EPD™ Grid Generator is the EPD™ Designers Grid Editor and includes functionality enabling a user to experiment using a pre-built EPD grid. A designer or researcher user of the EPD™ Designers Grid Editor is able to run ‘what-if’ scenarios as a result of the editor's functionality enabling modification of a pre-built grid, e.g., by changing the shape of the anode, the relative positions of the anode, cathode, and tank, or the number size, and position of holes in the cathode. FIG. 52 depicts a flow chart of a workflow incorporating both the EPD™ Grid Generator and the EPD™ Designers Grid Editor in an example scenario to determine the optimal placement of holes in a cathode.

### In Practice

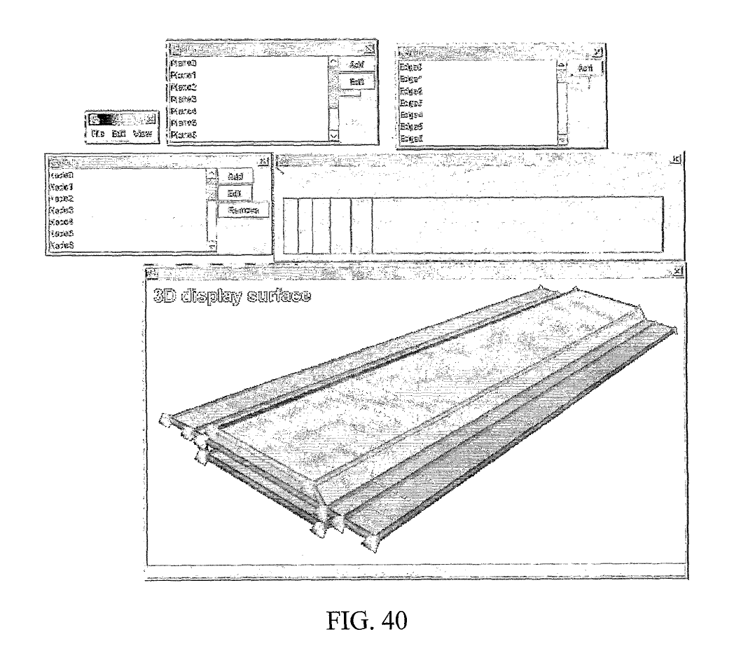

FIG. 40 depicts a screenshot of an example session using the EPD™ Grid Generator to construct a 3D thin surface model of a particular part. According to one embodiment, a manufacturer specified the particular part in a series of photographs and line drawings containing measurements. The information provided was used in conjunction with the EPD™ Grid Generator to construct the model and FIG. 40 depicts a step of the process.

The first three steps described in the flow chart (FIG. 39), and the penultimate step of applying a surface mesh, have interface elements visible in the screenshot (FIG. 40). The remaining steps, including checking for the direction of surface normals and for thin surface junctions, are performed automatically by the system as the model is constructed.

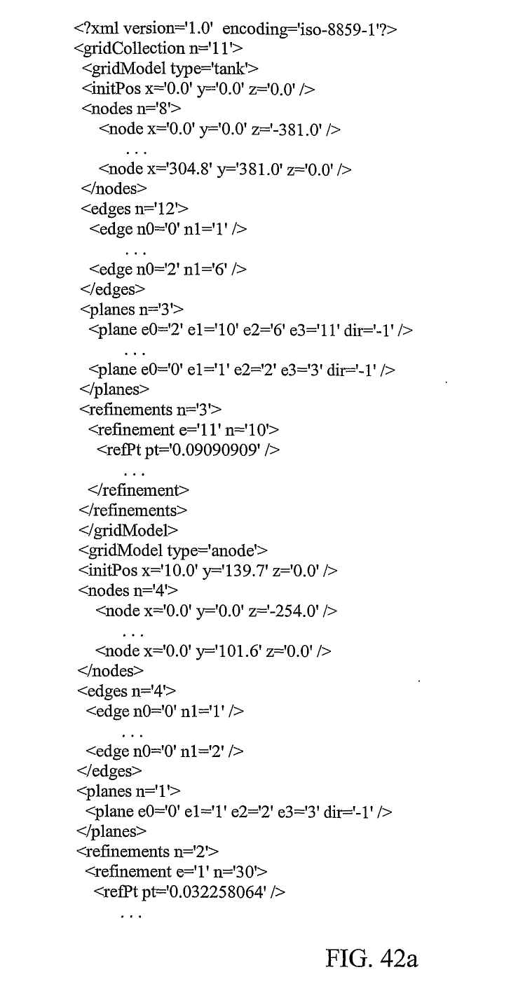

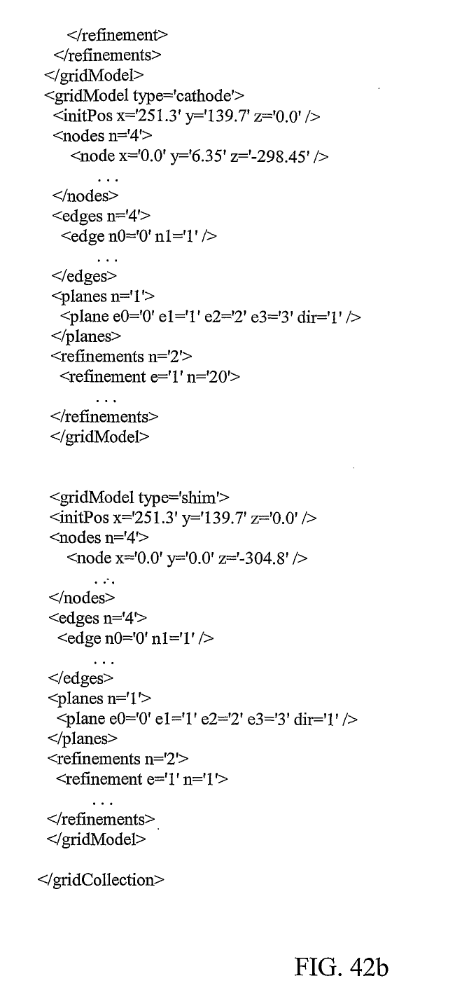

In the last step, a description of the 3D model is produced automatically in a markup language-based format, e.g., extensible markup language (XML). FIG. 42, made up of FIGS. 42a and 42b, depicts an example of a portion of the generated file.

### The EPD™ 3D Model Library

The XML description generated by the EPD™ Grid Generator is stored in the EPD™ 3D Model Library, e.g., an SQL database.

### EPD™ Project Manager

The EPD™ Project Manager is a subsystem responsible for the management of all data related to a project. Simulations are organized in a hierarchy by projects, within each of which different scenarios are constructed. Assignment of projects and scenarios is arbitrary and may be complicated or simple depending on the user's needs.

### Example Project

Determine the effect of using fewer anodes in the tank according to the size of the automobile model.

### Example Scenarios

Define three scenarios corresponding to three anode zones consisting of 2, 4, and 8 anodes. For each zone, place the cathode in several positions and measure the film build at a specified position on the cathode.

The EPD™ Project Manager contains tools for viewing results in three dimensions (3D), two dimensions (2D), and one dimension (1D), i.e., text. For example, in a computer automated engineering (CAE) environment, the viewing tools are a mandatory requirement for any system. For a system focusing on generating multiple “what-if” scenarios though, the tools are augmented with capabilities for exploring and comparing multiple datasets simultaneously.

A framework designed for displaying multiple results from the same simulation or multiple results from multiple simulations is used to enable comparison for different data dimensions (1D-numbers, 2D-graphs, 3D-objects). The framework, called a Comparison Palette, allows a user to compare different views in a palette. The user is able to manipulate each view independent of the other views, and when appropriate the combined display is advanced in time.

In a Comparison Palette, each data dimension (1D, 2D, 3D) has its own set of controls for manipulating views. For example, in the 3D case results are displayed in panels, each one of which has its own set of controls accessible via the mouse and a key of a keyboard for zooming, panning, and rotating the 3D object.

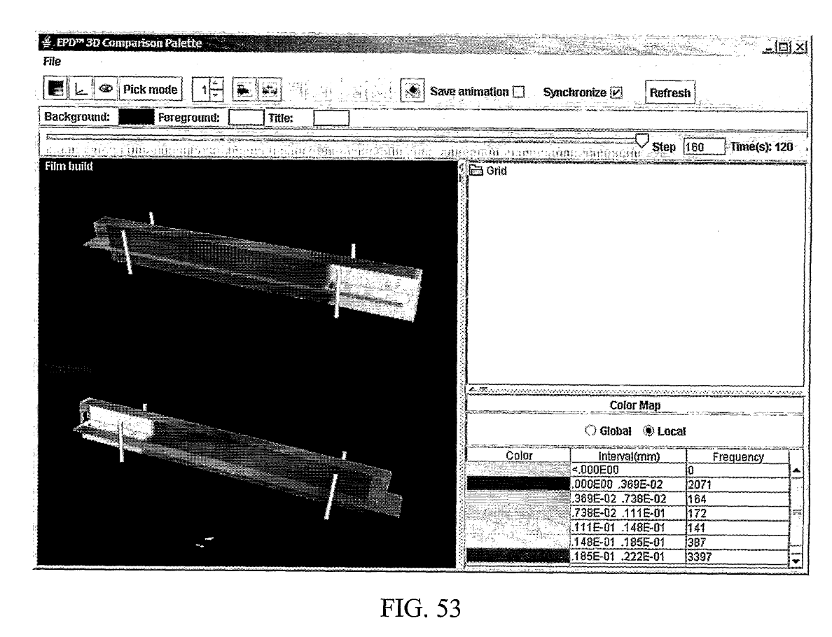

FIG. 53 depicts an example where the same object is displayed in two panels but from different views. In FIG. 53, the shadings represent values of film build on the 3D object as computed by the EPD Simulator.

Each view is individually manipulatable. For instance, each cathode can be rotated, zoomed, or have parts stripped away, independent of the other view(s). Moreover, the combined display can be synchronized and advanced in time so the combined progression of film build is viewable simultaneously.

The 3D Comparison Palette is usable to compare multiple result sets from the same simulation, e.g., for example film build, potential, current, or multiple result sets from multiple simulations. The only limit imposed on the number of panels able to be displayed is available memory.

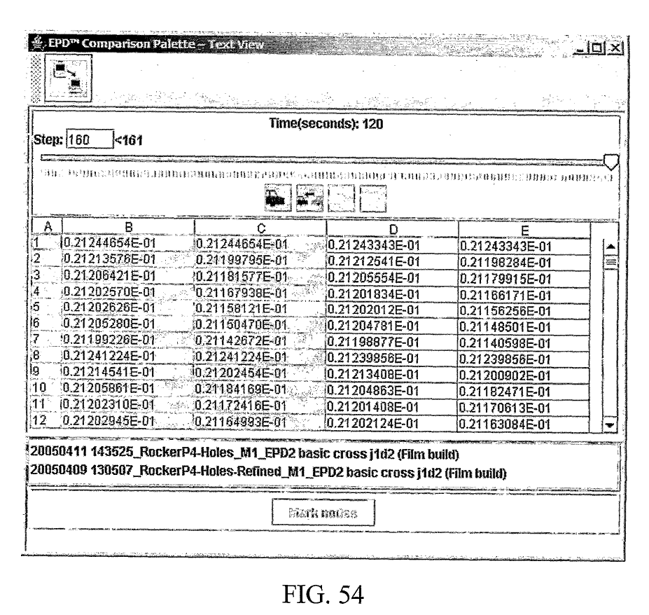

Sometimes, the raw numbers behind the 3D graphical contours must be compared and the 1D comparison Palette is used for this purpose as depicted in FIG. 54.

### Them EPD 3D Model Assembler

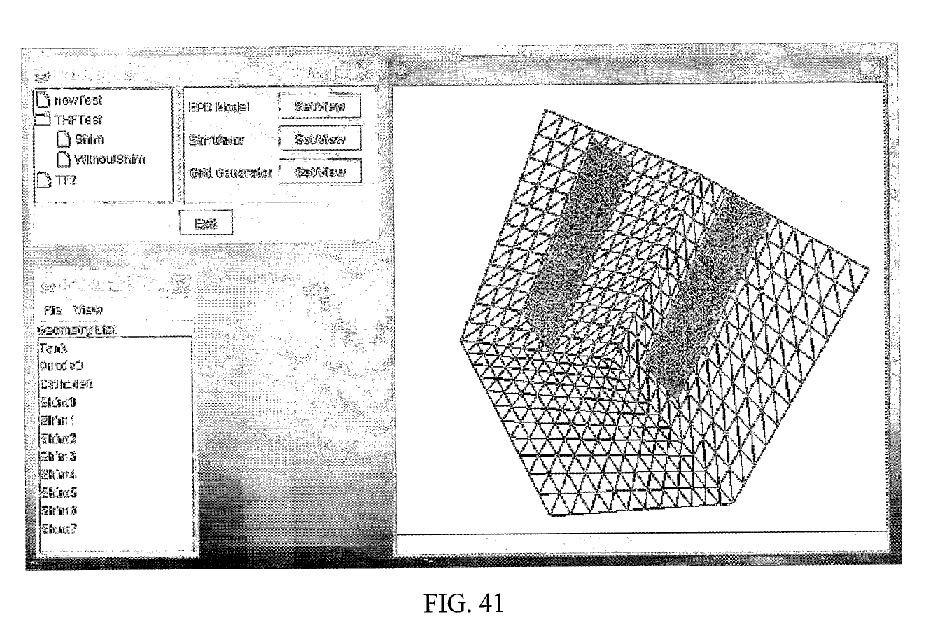

Input to the EPD™ Simulator includes 3D models of the cathodes, anodes, and tank required for a simulation. The input is assembled by selecting and combining 3D models from the EPD™ 3D Model Library. FIG. 41 depicts a screenshot of the EPD™ 3D Model Assembler.

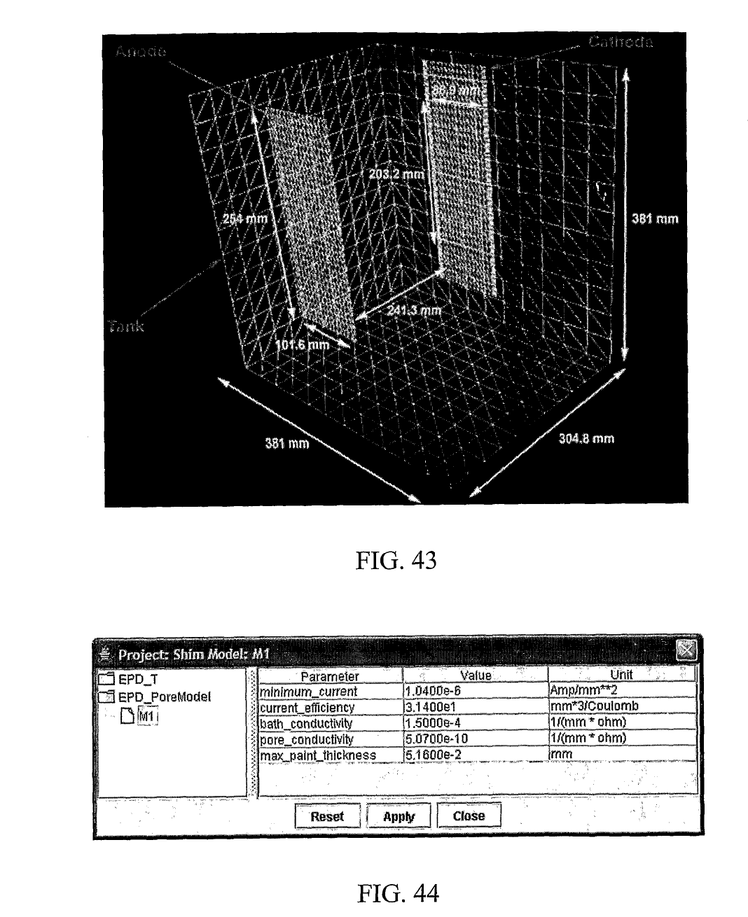

FIG. 41 depicts a project called Shim selected in the EPD™ Project Manager. On the right of the screen is the complete 3D geometry assembled from the 3D models for this project, all of which are displayed in the list box. The complete geometry is made up of one cathode, one tank, one anode, and 8 shims—plastic insulating strips placed around the cathode as depicted in FIG. 43.

An example of a portion of an input file generated by the EPD™ 3D Model Assembler, depicted in FIG. 42, made up of FIGS. 42a and 42b. FIG. 42 is only a portion of the entirety of an input file, repetitive portions having been removed, specifically, the additional shims and additional nodes defining the geometry of the cathode, anode, and tank. The file shows the data model used to hold different entities of the geometry, which in this case is depicted in FIG. 43.

### EPD™ Model Administrator

The EPD™ Model Administrator is a subsystem responsible for the management of paint models, their associated material parameters, and values.

The subsystem uses a standard SQL database to store different electrocoat materials with pre-assigned chemical and electrical properties and contains a graphical user interface with controls enabling a user to choose the material used in a simulation without worrying about the material properties. FIG. 44 depicts an example user interface for the EPD™ Model Administrator.

The subsystem uses a database, e.g., an SQL database, to store all data associated with a simulation and contains a graphical user interface for users to access project or scenario data without having to understand the underlying language or programming, e.g., the SQL language or SQL programming.

### EPD™ Facility Administrator

The EPD™ Facility Administrator is a subsystem to manage information and 3D models of a company's electrocoat tanks.

### Simulators

Several simulators are available depending on the computational environment available for executing EPD. As described previously, the EPD™ System provides a stand-alone version intended for execution by a single computer, such as a laptop, desktop, workstation, or supercomputer. The stand-alone version of the simulator operates in serial mode where a single processor is applied to execute a single simulation.

The EPD System also provides a parallel version, which applies multiple processors to execute a single simulation. The multiple processors may be housed in a single system, a cluster, or separate machines distributed worldwide.

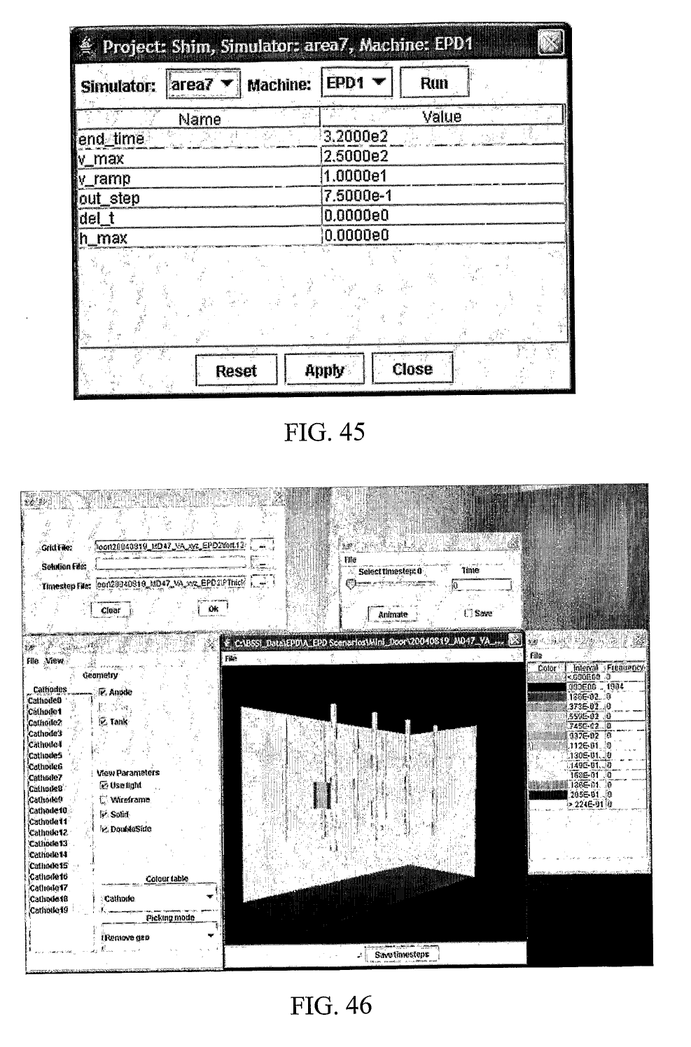

Graphical interface controls allow the user to select which simulator to run. For example, FIG. 45 depicts a user selection of a simulator called area7 and the associated runtime parameters.

### EPD™ Viewer

The EPD™ Viewer is the main tool for viewing and analyzing the results from the EPD™ Simulator and provides software functionality similar to the tasks performed by a person versed in the physical process of electro paint deposition. For example, users are familiar with painting physical prototypes, dissecting the prototypes afterward, and measuring to determine the thickness of paint deposited on the surface of the prototype. The EPD™ Viewer emulates these tasks in software.

Thus, instead of handling a physical prototype a user will interact with a 3D model, which may be rotated, zoomed, and examined in a similar manner. Instead of dissecting the prototype, the system allows the user to select different portions of the prototype, i.e., the thin surfaces. Finally, the process of measuring is transformed into a process enabling the user to select a point on the 3D model and the system computes and automatically displays the measurement.

FIG. 46 depicts a screenshot of graphical elements of the EPD™ Viewer.

The display window of FIG. 46, depicting the geometry including cathode, anodes, and tank, is a 3D environment navigable using user input devices, e.g., a mouse, etc. The geometry of the display window is able to be rotated, zoomed, and panned.

### Example—Selecting Thin Surfaces

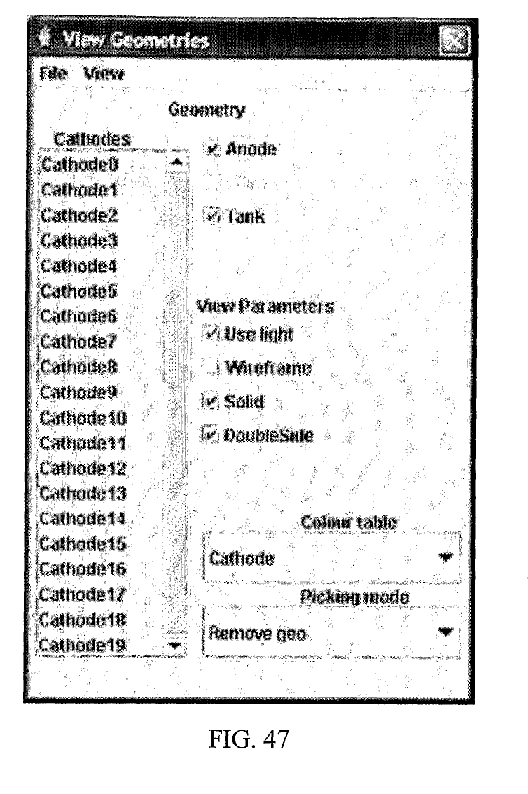

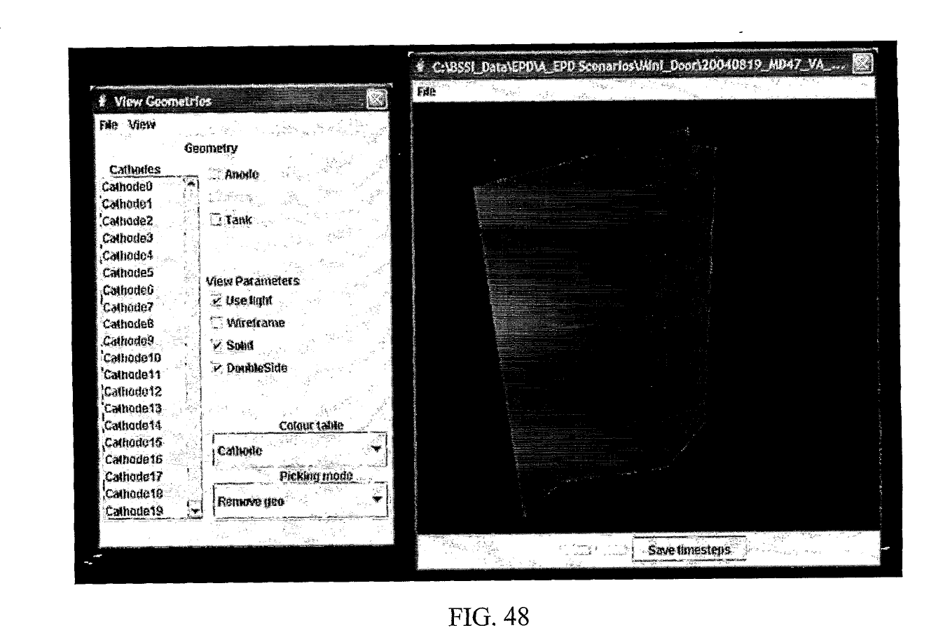

FIG. 47 depicts a screenshot of a window displaying the thin surfaces of the geometry. As noted previously, the above-described example includes 20 thin surface as depicted in FIGS. 16 and 48. As depicted in FIG. 48, the surfaces are labeled Cathode0 through Cathode19 within the EPD™ Viewer. Because all 20 surfaces are selected in FIG. 48, the display of the user interface displays the entire geometry; however, selecting only one or more items in the list, causes the selected thin surface to be hidden, i.e., not displayed in the display window. For example, with respect to FIG. 48, thin surface 13 is not displayed in the window as a result of the selection of Cathode12 list item.

Example—Measuring

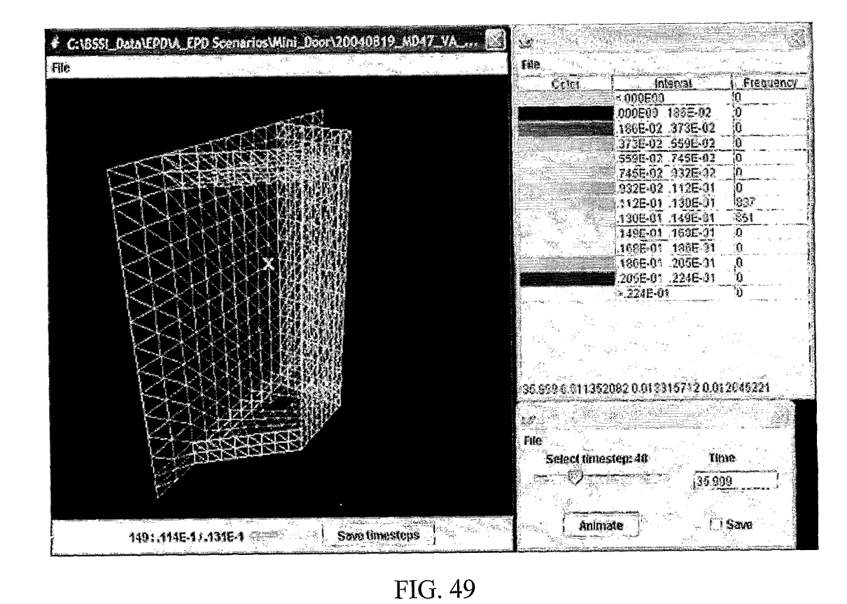

FIG. 49 depicts a user interface enabling a user to determine paint thickness inside a cavity at a particular point and at a specified time, e.g., 36 seconds into a paint simulation.

An important feature of the EPD™ Viewer is the ability to manipulate thin surfaces as depicted in the above-described FIGs. Another important feature is the ability to generate input to the EPD™ Simulator by selection of a subset of thin surfaces to include in the input. After performing an analysis, a subsection of a part analyzed may require further analysis. Instead of re-running the EPD Simulator using the geometry of the complete part, the EPD Viewer is used to select the subsection for further analysis.

The following references are hereby incorporated by reference herein in their entirety:
Reference 1. “Direct Evaluation of Hypersingular Galerkin Surface Integrals, L. J. Gray, J. M. Glaeser, T. Kaplan SIAM Journal on Scientific Computing, Volume 25, Number 5, pp. 1534-1556, (2004).”
Reference 2. “Determination of the Factors Affecting Electrocoat Paint Deposition using Design of Experiments”, R. M. Smith, J. Braslaw, and A. J. Forsgren, Ford Technical Report No. SR-95-062, Jun. 16, 1995.
Reference 3. Mathematical Theory of Finite and Boundary Element Methods, A. H. Schatz, V. Thomee, and W. L. Wendland, Birkhauser, Basel, Boston, Berlin, 1990

FIG. 55 is a block diagram illustrating an exemplary computer system 5500 upon which an embodiment may be implemented. Computer system 5500 includes a bus 5502 or other communication mechanism for communicating information, and a processor 5504 coupled with bus 5502 for processing information. Computer system 5500 also includes a memory 5506, such as a random access memory (RAM) or other dynamic storage device, coupled to the bus 5502 for storing instructions to be executed by processor 5504. Memory 5506 also may be used for storing lockorder values and calling point identifiers, temporary variables or other intermediate information during execution of instructions to be executed by processor 5504.

Computer system 5500 is coupled via bus 5502 to display 5508, such as a liquid crystal display (LCD) or other display technology, for displaying information to the user. Input device 5510, described above, is coupled to bus 5502 for communicating information and command selections to the processor 5504.

According to one embodiment, computer system 5500 operates in response to processor 5504 executing sequences of instructions contained in memory 5506 and responsive to input received via input device 5510, or communication interface 5512. Such instructions may be read into memory 5506 from a computer-readable medium or communication interface 5512.

Execution of the sequences of instructions contained in memory 5506 causes the processor 5504 to perform the process steps described above. In alternative embodiments, hard-wired circuitry may be used in place of or in combination with computer software instructions to implement the embodiments. Thus, embodiments are not limited to any specific combination of hardware circuitry and software.

Computer system 5500 also includes a communication interface 5512 coupled to the bus 5502. Communication interface 5512 provides two-way data communication. For example, communication interface 5512 may be a wireless communication link. In any such implementation, communication interface 5512 sends and receives electrical, electromagnetic or optical signals which carry digital data streams representing various types of information. Of particular note, the communications through interface 5512 may permit transmission or receipt of models, views, and results for display on display 5508.

Network link 5514 typically provides data communication through one or more networks to other devices. For example, network link 5514 may provide a connection through communication network 5516 to computer system 5518 or to data equipment operated by a service provider (not shown). The signals through the various networks and the signals on network link 5514 and through communication interface 5512, which carry the digital data to and from computer system 5500, are exemplary forms of carrier waves transporting the information. Computer system 5500 can send messages and receive data, including program code, through the network(s), network link 5514 and communication interface 5512. Received code may be executed by processor 5504 as it is received, and/or stored in memory 5506 for later execution. In this manner, computer system 5500 may obtain application code in the form of a carrier wave.

It will be readily seen by one of ordinary skill in the art that the present embodiments fulfill one or more of the advantages set forth above. After reading the foregoing specification, one of ordinary skill will be able to affect various changes, substitutions of equivalents and various other aspects of the embodiments as broadly disclosed herein. It is therefore intended that the protection granted hereon be limited only by the definition contained in the appended claims and equivalents thereof.

What is claimed is:

1. A system for predicting a characteristic of an object, comprising:
an object model comprising a thin crack geometry representation of at least a portion of the object;
a boundary condition model of a predetermined process applicable to the object; and
a simulator module for simulating the predetermined process applied to the object, the simulator module operable to apply the boundary condition model to the object model and to output a predicted value of a predetermined characteristic of the object.

2. The system of claim 1, wherein the simulation module comprises an integration module to output the predicted value at a predetermined time in the predetermined process.

3. The system of claim 2, wherein the object model comprises at least two thin surface representations having continuous normal vectors when moving in a predetermined direction relative to the at least two surfaces.

4. The system of claim 2, wherein the predetermined process comprises at least one of an electrochemical process, a deposition process, a thermal process, and a crack propagation process.

5. The system of claim 1, wherein the boundary condition model comprises a Green's function.

6. The system of claim 1, wherein the object model partitions the object into pieces represented using thin crack geometry.

7. The system of claim 6, wherein the boundary condition model is applied to re-stitch object model pieces.

8. A simulation system, comprising:
an object model comprising a first mathematical expression of a predetermined set of object characteristics associated with a predetermined object, wherein the first mathematical expression at least partially comprises thin crack geometry;
a process model comprising a second mathematical expression of a predetermined set of process parameters associated with a predetermined process applicable to the predetermined object;
an environment model comprising a third mathematical expression of a set of environment characteristics associated with a predetermined environment in communication with the predetermined process and the predetermined object; and
a simulation module operable to apply boundary integral methods to the process model, the object model and the environment model to predict one or more predetermined characteristics of at least one of the predetermined object, the predetermined process and the predetermined environment based on an interaction of the process model, the object model and the environment model.

9. A system for predicting an amount of deposition of a coating on an object, comprising:
an object model comprising a thin crack geometry representation of at least a portion of the object;
a boundary condition model of a predetermined deposition process applicable to the object; and
a simulator module for simulating application of the predetermined deposition process to the object, the simulator module operable to apply the boundary condition model to the object model and to output a predicted amount of coating applied to the object.

10. The system of claim 9, wherein the simulation module comprises an integration module operable to output the predicted amount of coating at a predetermined time in the predetermined deposition process.

11. The system of claim 9, wherein the boundary condition model comprises a Green's function.

12. A system for predicting a dryness of a coating on an object, comprising:
an object model comprising a thin crack geometry representation of at least a portion of the object or the coating;
a boundary condition model of a predetermined thermal process applicable to the object; and
a simulator module for simulating application of the predetermined thermal process to the object, the simulator module operable to apply the boundary condition model to the object model and to output a predicted amount of dryness of the coating.

13. The system of claim 12, wherein the boundary condition model comprises a Green's function.

14. The system of claim 12, wherein the simulation module comprises an integration module operable to output the predicted amount of dryness of the coating at a predetermined time in the predetermined thermal process.

15. A method for predicting a characteristic of an object, comprising:
receiving an object model comprising a thin crack geometry representation of at least a portion of the object;
receiving a boundary condition model of a predetermined process applicable to the object; and
performing a simulation of application of the predetermined process to the object, where the simulation is operable to apply the boundary condition model to the object model and to output a predicted value of a predetermined characteristic of the object.

16. The method of claim 15, where the boundary condition model comprises a Green's function.

17. The method of claim 15, where performing the simulation further comprises an integration to output the predicted value at a predetermined time in the predetermined process.

18. The method of claim 16, where creating the object model further comprises creating at least two thin surface representations having continuous normal vectors when moving in a predetermined direction relative to the at least two surfaces.

19. The method of claim 15, where the predetermined process comprises at least one of an electrochemical process, a deposition process, a thermal process, and a crack propagation process.

20. A computer-readable medium comprising:
at least one sequence of instructions, wherein execution of the instructions by a computer causes the computer to:
output a predicted value of a characteristic of an object based on simulating a predetermined process applied to the object, the object modeled using a thin crack geometry representation of at least a portion of the object, the particular process modeled using a boundary condition model.

21. The medium of claim 20, wherein the predetermined process comprises at least one of an electrochemical process, a deposition process, a thermal process, and a crack propagation process.

22. The medium of claim 20, wherein the boundary condition model comprises a Green's function.

23. The medium of claim 20, wherein the predicted value output is based on simulating the predetermined process applied to the object at a predetermined time.

24. The medium of claim 20, wherein the predicted value output is based on performing an integration to output the predicted value at a predetermined time according to the predetermined process.

25. A computer system for simulating a process applied to an object over time comprising:
a processor; and
a memory coupled to the processor, the memory having stored therein sequences of instructions which, when executed by the processor, cause the processor to:
output a predicted value of a characteristic of the object based on simulating the process applied to the object using predetermined models, the object modeled using a thin crack geometry representation of at least a portion of the object, the process modeled using a boundary condition model.

26. The medium of claim 25, wherein the process comprises at least one of an electrochemical process, a deposition process, a thermal process, and a crack propagation process.

27. The medium of claim 25, wherein the boundary condition model comprises a Green's function.

28. The medium of claim 25, wherein the predicted value output is based on simulating the process applied to the object at a predetermined time.

29. The medium of claim 25, wherein the predicted value output is based on performing an integration with the predetermined models to output the predicted value at a predetermined time.
